(19) United States
(12) Patent Application Publication
(10) Pub. No.: US 2018/0131667 A1
(43) Pub. Date: May 10, 2018

(54) SYSTEMS AND METHODS TO VERIFY OWNERSHIP OF A TELEPHONE NUMBER AND TO TRACK OWNERSHIP REASSIGNMENTS

(71) Applicant: Danal Inc., San Jose, CA (US)

(72) Inventors: Ritesh Jain, San Jose, CA (US); Paris Leung, San Jose, CA (US); Sreekant Vijayakumar, San Jose, CA (US); Akshay Joglekar, San Jose, CA (US)

(21) Appl. No.: 15/348,843

(22) Filed: Nov. 10, 2016

(51) Int. Cl. H04L 29/12

(52) U.S. Cl. CPC H04L 61/1576; H04L 61/605; H04L 61/1588; H04L 61/2076; H04L 61/2084

(57) ABSTRACT

The ownership verification and reassignment tracking solution of the present disclosure can be used to identify if a telephone number belongs to a stated customer of a business and identify any change in the telephone status on a periodic basis to ensure continued ownership of the telephone number with the stated customer. Real-time telephone number ownership and disconnection and port history can be used. This data can be accessed directly from the telephony carriers. Ownership and porting data from publicly available data sources can also be used, in some embodiments, to provide complex and comprehensive ownership verification and ownership reassignment tracking for a telephone number.

The present disclosure relates to verifying ownership of a telephone number and to tracking telephone number ownership reassignment. More particularly, the disclosure relates to an aggregator system capable of receiving real-time ownership data relating to a telephone number from multiple telephone carrier systems, receiving disconnection and port history for that telephone number, and to verifying the telephone number ownership based on the received ownership data and on the disconnection and port history.

### BACKGROUND

Telephony carrier systems recycle millions of telephone numbers every year. Ownership of a telephone number may, at any time, switch from one customer to another. Any one of many different events, such as moving, marriage, divorce, new telephone service, etc. may cause a customer to give up an existing telephone number and get a new telephone number. A telephone number may also be suspended, or revoked for non-payment of telephone network services.

Merchants and service providers such as banks, cable companies, insurance providers, and healthcare providers have a need to know the correct telephone numbers for their customers in order to provide services to them. Verifying telephone number ownership is important for many different reasons for businesses. For example, telephone number ownership verification may help merchants identify and mitigate fraud and ensure compliance with regulations such as the Telephone Consumer Protection Act (TCPA). However, customers often fail to proactively notify the merchants about their telephone number changes. In such situations, it becomes very difficult for merchants to ensure that they are transacting with the correct customer or that they are contacting the correct customer.

In addition, the constantly changing regulatory environment often leaves businesses facing enormous consequences with little time to act. The Federal Communications Commission (FCC) requires businesses to ensure that they are contacting the correct party. With telephone owners frequently switching networks provided by different telephony carriers and telephone numbers, businesses need a compliance solution that can keep up with consumers' ever-changing behavior.

### BRIEF DESCRIPTION OF THE FIGURES

The above and other features of the present disclosure, its nature and various advantages will be more apparent upon consideration of the following detailed description, taken in conjunction with the accompanying drawings in which:

FIG. 1 is a block diagram of illustrative systems and devices implemented in a network environment in accordance with some embodiments of the present disclosure;

FIG. 2 is a block diagram showing illustrative paths of communication between systems and devices in accordance with some embodiments of the present disclosure;

FIG. 3 is a block diagram of an illustrative aggregator system in accordance with some embodiments of the present disclosure;

FIG. 4 is a block diagram of an illustrative merchant system in accordance with some embodiments of the present disclosure;

FIG. 5 is a block diagram of an illustrative carrier system in accordance with some embodiments of the present disclosure;

FIG. 6 is a block diagram of an illustrative client device in accordance with some embodiments of the present disclosure;

FIG. 7A is a block diagram showing an illustrative data flow as part of a telephone number ownership verification process in accordance with some embodiments of the present disclosure;

FIG. 7B is a block diagram showing an illustrative data flow as part of a telephone number reassignment tracking process in accordance with some embodiments of the present disclosure;

FIG. 7C is a flow chart of illustrative steps performed by an aggregator to verify telephone number ownership and to conduct reassignment tracking in accordance with some embodiments of the present disclosure;

FIG. 8 is a flow chart of illustrative steps performed by an aggregator to determine last possible date of reassignment as a part of the process of verifying telephone number ownership in accordance with some embodiments of the present disclosure;

FIG. 9 is a flow chart of illustrative steps performed by an aggregator to determine ownership verification score as a part of the process of verifying telephone number ownership in accordance with some embodiments of the present disclosure; and

FIG. 10 is a flow chart of illustrative steps performed by an aggregator to conduct reassignment tracking in accordance with some embodiments of the present disclosure.

### DETAILED DESCRIPTION

The present disclosure is directed to an aggregator system (also referred to herein as an aggregator) that is communicatively connected to multiple telephony carrier systems. In some embodiments, the aggregator system is connected to, for example, all major United States mobile networks provided by major telephony carriers and to all major landline telephony carries. The aggregator system may be configured to receive real-time ownership verification data from the multiple telephony carrier systems. Real-time data refers to up-to-date data or to data that is provided substantially in real-time. In some embodiments, real-time data refers to data that is accurate to within a second. The aggregator system is also configured to receive disconnection and port history from the multiple telephony carriers. In some embodiments, the aggregator system is configured to receive telephone number type data (e.g., landline/mobile), and telephone number status data (e.g., active/inactive) from the multiple telephony carriers. In some embodiments, the aggregator system is also configured to receive ownership data from public data sources. A successful compliance solution, disclosed herein, utilizes accurate real time data, thereby enabling businesses to keep up with their consumers and FCC regulations. An authoritative source for real-time consumer telephone information is the telephony carriers.

The aggregator system, disclosed herein, connects to live Customer Relationship Management (CRM) databases of all major United States mobile telephony carriers and landline telephony carriers and provides a comprehensive and accurate telephone number ownership verification and telephone number ownership reassignment tracking. The aggregator system performs live ownership verification of a telephone number and packages it with other data such as telephone number type (e.g., landline/mobile), telephone number status (e.g., active/inactive), and deactivation and port history for the telephone number. The aggregator system determines ownership verification score for each telephone number based on the various data points retrieved from the telephony carriers. The aggregator system also tracks telephone numbers for ownership reassignments, ports from landline to mobile telephony carrier or vice-versa, and any other change in status of a telephone number that may prompt a merchant to either suspend or stop dialing or autodialing a telephone number. The solution disclosed herein has two parts: performing the telephone number ownership verification and continuously tracking any reassignments in ownership of the telephone number.

The aggregator system significantly improves telephone number ownership verification by leveraging access to the aforementioned data. Specifically, by having concurrent access to real-time ownership data from multiple telephony carrier systems, access to disconnection and port history, and access to other aforementioned types of data, the aggregator system is able to verify ownership of a telephone number more quickly and more precisely. In particular, an aggregator system, using methods disclosed below, is able to verify telephone number ownership more quickly and more precisely than conventional systems.

In addition, once ownership of the telephone number is verified, the aggregator system of the present disclosure may track ownership reassignment by using data from disconnection and port history and from telephone lookup services, such as Electronic Number Mapping System (ENUM). The aggregator system forwards the results of the ownership verification and reassignment tracking to a merchant system, allowing the merchant system to maintain the up-to-date customer database. Consequently, methods and systems disclosed below, in accordance with some embodiments of the present disclosure, provide a significant improvement in the field of telephone number ownership verification and reassignment tracking.

For purposes of this disclosure the term “telephony carrier” or “telephony carrier system” refers to any device, system, or organization that provides telephony service to customers. For example, telephony carrier may refer to a provider of a mobile telephone service or an operator of a mobile telephone network, such as a cellular network. In another example, telephony carrier may refer to a provider of a landline telephone service.

For purposes of this disclosure, the term “customer data” refers to data relating to a customer. For example, customer data may include customer name, telephone number, address, telephone type, financial information, personal information, any other information relating to the customer, or a combination thereof. Customer data may be maintained by a merchant, a service provider, an educational institution, a financial institution, a government authority, a non-profit organization, or any other person or organization that maintain information about customers.

For purposes of this disclosure, the term “telephone number ownership data” provided by a carrier system refers to real-time ownership data for a telephone number provided by at least one telephony carrier. For example, telephone number ownership data may identify the name of a customer who currently owns that telephone number, and an address of that customer. In some embodiments, “phone number ownership data” may refer to ownership data for a telephone number provided by other sources or sources, for example, by at least one public data source.

For purposes of this disclosure, the term “ownership match score” refers to a score determined based on a match performed for the name and address contained in the customer data against the name and address contained in telephone number ownership data received from at least one telephony carrier. Ownership match scores may vary. A higher ownership match score may indicate a higher confidence in the match. Each individual attribute in name and address may be scored separately to determine the ownership match score.

For purposes of this disclosure, the term “telephone lookup service data” refers to data received in response to a telephone lookup service request. For example, a request for telephone lookup service data may contain a telephone number. The telephone lookup service response to such a request may provide a telephony carrier name and the type of network associated with that telephone number. For example, the type of network may be one of “Mobile,” “Landline,” “VOIP,” or any other network type. In some embodiments, data in an Electronic Number Mapping System (ENUM) response may be a type of telephone lookup service data.

For purposes of this disclosure the term “account level details” refers to telephone account details that are retrieved from at least one telephony carrier. Account level details may be real time data that is accurate up to, for example, a second. Account level details may indicate if the telephone number is a prepaid or postpaid, and if the telephone number is currently active or not.

For purposes of this disclosure the term “disconnection and port history” refers to a list of activities for a telephone number provided by one or more telephony carriers. Disconnection and port history for a telephone number may include swap activities, deactivation activities, reactivation activities, suspension activities, port activities, other telephone activities, or any combination thereof associated with the telephone number. Swap activity is an activity indicating that the telephone number was swapped by the customer. That is, that the customer has given up his number and switched to another number provided by the same telephony carrier. Deactivation activity is an activity indicating that the telephone number was deactivated by the carrier. Deactivation activity may occur when the customer request deactivation, due to a non-payment, or due to any other reason. Reactivation activity is an activity indicating that the telephone number that was deactivated is now reactivated by the same customer. In some embodiments, carriers provide a grace period during which a customer may reactivate a number that was previously deactivated. Suspension activity is an activity indicating that the telephone number was temporarily suspend by the carrier. Port activity is an activity indicating that the customer has transferred his telephone number from one telephony carrier to another telephony carrier.

For purposes of this disclosure the term “Last Possible Reassignment Date” (LPRD) refers to a last possible date on which a telephone number was reassigned. For example, LPRD may refer to a last possible date on which the customer has swapped the telephone number for another telephone number on the same telephony carrier. LPRD may refer to a last possible date on which the telephone number was reassigned to a different customer by the telephony carrier. In some embodiments, LPRD may be determined based on disconnection and port history.

For purposes of this disclosure the term “telephone elements data” refers to data containing at least one of disconnection and port history, account number type, and account level details. Telephone elements data may be received from at least one telephony carrier.

For purposes of this disclosure the term “telephone elements score” refers to a score obtained based on at least one of disconnection and port history, account number type, and account level details. For example, telephone elements score may be based on LPRD being compared to a date on which the ownership of the telephone number was last verified or to date on which the customer was last successfully contacted. Telephone elements score may also be based on comparison of account level details with customer data.

For purposes of this disclosure the term “ownership verification score” refers to an overall score that indicates the probability that a person whose name is listed in the customer data currently owns the telephone number listed in the customer data. This ownership verification score may be based on at least one of ownership match score and on telephone elements score.

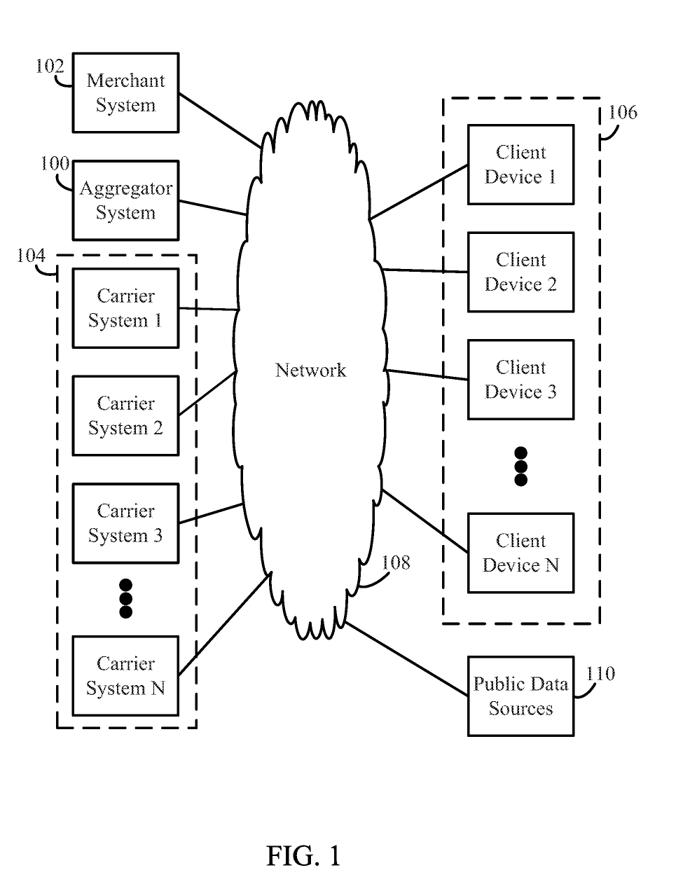

FIG. 1 is a block diagram of illustrative systems and devices implemented in a network environment in accordance with some embodiments of the present disclosure. Aggregator system 100, merchant system 102, multiple carrier systems 1-N 104, public data sources 110, and multiple client devices 1-N 106 may be coupled via network 108. Network 108 may include or communicate with any suitable one or more network structure or structures, such any suitable local area network (LAN), wide area network (WAN) (e.g., the internet), wireless local area network (WLAN), a mobile communications network, any other suitable network, or any combination thereof. In some embodiments, network 108 is a network operated by one or more carriers of the multiple carrier systems 1-N 104. The lines coupling network 108 to the various systems and devices may represent a wireless coupling, a wired coupling, any other suitable coupling, or any combination thereof. For example, devices and systems may be connected to network 108 through a WiFi or Ethernet connection, with access to the internet. In another example, one or more of the client devices 1-N 106 are coupled to network 108 using one or more mobile communications networks, such as a 3G, 4G, LTE, cellular network, any other suitable mobile communications network, or any combination thereof.

Aggregator system 100 may be any suitable system which acts as an intermediary between two or more systems, such as client devices 1-N 106 and carrier systems 1-N 104, merchant system 102 and carrier system 104, client devices 1-N 106, merchant system 102, public data sources 110, between any other systems and devices, or any combination thereof. Aggregator system 100 may act as an intermediary by facilitating the communication of information, such as payment information (e.g. credit card information, PayPal information, routing number data, bank account information, billing address, legal name, social security number, any other suitable information related to making a payment, or any combination thereof) and/or registration information (e.g., name, address, email, telephone number, social security number, payment information, any other suitable information, or any combination thereof), and/or telephone number ownership information between two systems. Aggregator system 100 may be trusted by each of carrier systems 1-N 104, and may access customer relationship management (CRM) information stored in one or more carriers of the carrier systems 1-N 104 for secure communication to merchant system 102 or client devices 1-N 106. An example of aggregator system 100 is the system developed and operated by Danal Inc. (doing business as BilltoMobile) located in San Jose, CA, which provides mobile payment services to merchants using data provided by United States carrier systems. In some embodiments of the present disclosure, aggregator system 100 is configured to compile and verify information about client devices 1-N 106. For example, aggregator system 100 may be configured to receive customer data from merchant system 102, verify telephone number ownership contained in the customer data and perform ownership reassignment tracking relating to the telephone number.

Merchant system 102 may be any suitable one or more entities capable of entering into a transaction with a client device. Examples of a transaction include a purchase transaction for goods, services, or both provided by merchant system 102, a money transfer, a bill payment, a transaction that results in access to banking information, banking services, or both, any other suitable transaction, or any combination thereof. Merchant system 102 may include, for example, a web server that publishes a website which requires personal information (e.g., payment information, registration information). Merchant system 102 may maintain a list of customers along with associated customer data, including: customer name, telephone number, address, telephone type, financial information, personal information, any other information relating to the customer, or a combination thereof. Examples of merchant system 102 include systems operated by Amazon.com, Citibank, freecreditscore.com, among others. In some embodiments, merchant system 102 may be configured to communicate with one or more of clients devices 1-N 106 (e.g., to enable a transaction) using network 108.

Each telephony carrier system of telephony carrier systems 1-N 104 may be any suitable one or more distinct systems which provides telephone and/or data network services to client devices 1-N 106, including any one of mobile telephone network service, landline telephone network service, mobile network service, any other type of network service, or any combination thereof. For example, a carrier system of carrier systems 1-N 104 may include one or more mobile network operators, one or more telephone network operators, one or more landline operators, or any combination thereof. Providing mobile network services to one or more of the client devices 1-N 106 may include providing a carrier network to client devices 1-N 106. For example, a carrier system may be a system operated by Verizon, Sprint, or AT&T.

Each of the client devices 1-N 106 may include any suitable hardware, software, or both that can be used to conduct a transaction with merchant system 102 using the carrier network provided by one or more carriers of the carrier systems 1-N 104. In some embodiments, one or more of the client devices 1-N 106 may be a mobile telephone. A mobile telephone may be associated with a mobile telephone number, a carrier system, any other mobile telephone identification information, or any combination thereof. In some embodiments, one or more of the client devices 1-N 106 may be a landline telephone. A landline telephone may be associated with a telephone number, a telephone provider system, any other mobile telephone identification information, or any combination thereof. Each client device of the client devices 1-N 106 may be a tablet device, laptop device, any other suitable client device, mobile or otherwise, or any combination thereof. In some embodiments, one or more carrier system of the carrier systems 1-N 104 may include or have access to CRM information associated with any one of client devices 1-N 106, and may be configured to communicate the CRM information to aggregator system 100 via network 108.

Public data sources 110 may include any systems or devices that provides data that is publicly accessible. For example, public data sources 110 may include one or more of internet-accessible databases, white pages listings, social media database, any other public available data sources or any combination thereof. In some embodiments, public data sources 110 may include one or more of telephone number ownership data services provided by Lexis Nexis™ and by NuStar™. Aggregator system 100 may be able to access public data sources 110 over network 108. In some embodiments, aggregator system 100 may be configured to use data from public data sources 110 to verify telephone number ownership.

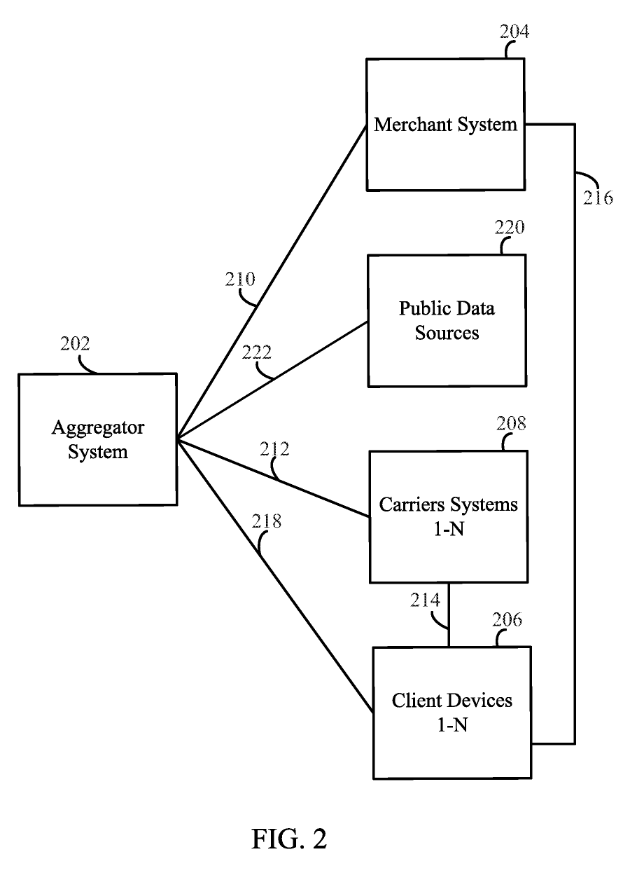

FIG. 2 is block diagram showing illustrative paths of communication between the systems and devices of FIG. 1 in accordance with some embodiments of the present disclosure. Aggregator system 202 may be configured to communicate with merchant system 204, carrier systems 1-N 208, public sources data sources 220, and client devices 1-N 206 via communications channels 210, 212, 222, and 218 respectively. Merchant system 204 may be configured to communicate with aggregator system 202 and with client devices 1-N 206 via communication channels 210 and 216 respectively. Client devices 1-N 206 may be configured to communicate with merchant system 204, with aggregator system 202, and with carrier system 208 via communication channels 216, 218, and 214 respectively. Carrier systems 1-N 208 may be configured to communicate with aggregator system 202 and with client devices 1-N 206 via communication channels 212 and 214 respectively. Aggregator system 202 may be configured to communicate with public data sources 220 via communication channel 222. Communication between systems and devices may include communicating over a network, such as network 108 of FIG. 1, and may include receiving data, sending data, or both.

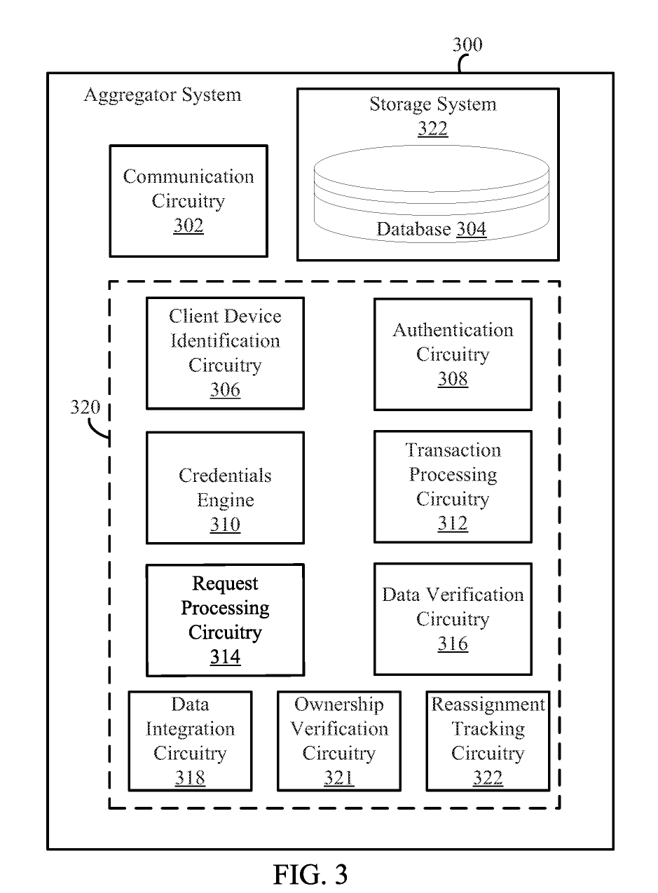

FIG. 3 is a block diagram of illustrative aggregator system 300 in accordance with some embodiments of the present disclosure. Aggregator system 300 may be any suitable aggregator system, such as aggregator system 100 of FIG. 1 or aggregator system 202 of FIG. 2. In some embodiments, aggregator system 300 may be implemented in a network environment, such as that of FIG. 1. Aggregator system 300 may include any suitable software, hardware, or both configured to implement the features as described herein. For example, aggregator system 300 may include server hardware and software. Aggregator system 300 may include communication circuitry 302, storage system 322, and processing equipment 320.

Communication circuitry 302 may be configured with any suitable software, hardwired instructions, or both to communicate with database 304 and processing equipment 320, and may include inputs, outputs, any other mechanisms which facilitate communication with other systems and devices, or any combination thereof. An input or output is a relative communication channel that can be used to receive or send data, respectively. A communication channel may be established as, for example, an IP protocol-based communications session using any suitable network infrastructure, including the Internet, any proprietary LAN, WAN, any other suitable network infrastructure, or any combination thereof. Inputs and outputs can be implemented as one or more physical ports, a data storage device, any other suitable hardware interface, software interface, or any combination thereof. For example, aggregator system 300 may include a carrier input coupled to a carrier system and configured to receive data from the carrier system, a carrier output coupled to the carrier system and configured to output data to the carrier system, a merchant input coupled to a merchant system and configured to receive data from the merchant system, a merchant output coupled to the merchant system and configured to output data to the merchant system, a client device input coupled to a client device and configured to receive data from the client device, a client device output coupled to the client device and configured to output data to the client device, any other suitable input or output, or any combination thereof. Aggregator system 300 may also include a public data input configured to receive data from public data sources. In some embodiments, aggregator system 300 may include inputs configured to receive real-time telephone number ownership data from telephony carriers, telephone number ownership data from public data sources, disconnection and port history from mobile telephony carriers and landline telephony carriers, and data from telephony carriers' telephone lookup services. While different inputs and outputs are described, it will be understood that they need not be separate components and two or more of the inputs and/or outputs may be implemented as a single component that can be used to send or receive data relative to more than one destination or source, respectively. For example, communication circuitry 302 may include a transceiver, such as an Ethernet card, or any other suitable device or circuitry which facilitates communication with other systems and devices.

Storage system 322 may include any suitable hardware, software, or both for implementing an organized data storage system capable of storing one or more databases and information related to, for example, merchant data, client device data, user data, authentication, rules, and carrier data. For example, storage system 322 may include database 304. In some embodiments, storage system 322 may store information which is not stored in database 304, such as information related to, for example application programming interfaces (APIs), HTML for content pages, any other suitable information, and any combination thereof.

Database 304 may include any suitable hardware, software, or both for implementing an organized data storage system capable of storing information related to, for example, merchant data, client device data, user data, and carrier data. Information related to merchant data may include, for example, stock keeping units (SKUs) related to goods for sale, customer service contact information (e.g., a telephone number, an email address, a hyperlink for a website), data related to criteria for revoking authentication, any other merchant data, or any combination thereof. Information related to client device data may include, for example, a mobile device number, identification information associated with a client device, any other client device data, or any combination thereof. In some embodiments, database 304 may store encrypted information. For example, hashed information may be generated using a hash operation, and the hashed information may be stored in database 304. In some embodiments, aggregator system 300, or any processing equipment or database thereof, such as database 304, may temporarily store CRM information associated with a user solely for the purpose of providing information where aggregator system 300 acts as an intermediary between systems and client devices, such that the user's privacy is preserved. For example, aggregator system 300 may temporarily store CRM information associated with a user of a client device until the information is communicated to a merchant system, where aggregator system 300 is configured to act as an intermediary between the merchant system and the client device. For example, aggregator system 300 may temporarily or permanently store customer data for the purpose of verifying telephone number ownership and/or conducting telephone number reassignment tracking. If aggregator system 300, or any processing equipment or database thereof is deemed to be a trusted system by a carrier system that stores CRM information, and if permission is granted to aggregator system 300 by the carrier system, then aggregator system 300 or any processing equipment or database thereof may be configured to store CRM information.

Processing equipment 320 may be any suitable hardware, software, or both configured to process data received from other systems and devices (e.g., a client device, a merchant system, a carrier system, or any other suitable system or device), process data to be output to other systems and devices, generate data (e.g., generate authentication information), analyze data (e.g., identify a client device based on identification information), and perform other tasks. In some embodiments, processing equipment 320 may include one or more circuitries for performing the functionality as described herein, such as client device identification circuitry 306, authentication circuitry 308, credential engine 310, transaction processing circuitry 312, request processing circuitry 314, data verification circuitry 316, data integration circuitry 318, ownership verification circuitry 321, reassignment tracking circuitry 322, any other suitable processing equipment, or any combination thereof. The circuitries within processing equipment 320 may communicate with one another to implement the features as described herein. Additionally, the circuitries within processing equipment 320 may all be implemented together on one or more devices. In some embodiments, processing equipment 320 may communicate with communication circuitry 302 and database 304 to retrieve or transmit information (e.g. identification information, authentication information, any other suitable information, or any combination thereof). For example, processing equipment 320 may send identifying information associated with a client device, such as a mobile telephone number, to database 304 to retrieve additional information related to the client device or user in possession of the client device.

Client device identification circuitry 306 may be configured with any suitable software, hardwired instructions, or both to identify a client device based on client device identification information. For example, client device identification circuitry 306 may be at least a portion of one or more integrated circuit processors. Identifying a client device may enable aggregator system 300 to access information associated with the client device, to communicate with the client device, to authenticate the client device, to process a transaction on the client device, to perform any other suitable action, or any combination thereof. In some embodiments, client device identification circuitry 306 may be configured to store client device identification information in a database, such as database 304, and may be configured to identify a client device based at least in part on information stored in database 304. Client device identification information may include, for example, information identifying a mobile telephone number associated with the client device, information identifying a carrier system associated with the client device, information identifying software or hardware of the client device, information identifying a user in possession of the client device, any other suitable identification information, or any combination thereof. For example, client device identification circuitry 306 may identify a client device by identifying and storing a mobile telephone number associated with a client device based on client device identification information which is received from a carrier system.

Authentication circuitry 308 may be configured with any suitable software, hardwired instructions, or both to authenticate a client device. For example, authentication circuitry 308 may be at least a portion of one or more integrated circuit processors. In some embodiments, authenticating a client device may allow the client device to receive or request protected information (e.g., payment information), for example, as a part of a transaction. Authenticating a client device may include authenticating a user in possession of the client device. In some embodiments, authenticating a user in possession of a client device may include verifying the identity of the user. Verifying a user's identity may include, for example, requesting the user to provide uniquely identifying information, requesting the user to provide a unique one-time pin, requesting the user to send a particular MO message, requesting the user to send a particular silent MO message, requesting the user to complete any other suitable request, or any combination thereof. In some embodiments, authenticating a client device may include comparing any provided information related to a user in possession of a client device to any information stored in database 304, for example, to detect differences between the provided information and the information stored in database 304. In some embodiments, authentication circuitry 308 may be further configured to generate data which can be used to prove authentication, such as authentication keys, credential information, any other suitable information, or any combination thereof. For example, authentication circuitry 308 may be configured to generate credentials for an authenticated user in possession of a client device.

Credential engine 310 may be any suitable hardware, software, or both configured to determine criteria for revoking authentication for an identified client device. Revoking authentication for an identified client device may prohibit the client device from participating in interactions which require authentication (e.g., requesting protected information for use in a transaction). In some embodiments, revoking authentication for an identified client device may include invalidating credentials for an authenticated user in possession of the client device. Credential engine 310 may be configured to define criteria based on rules for revoking authentication received from a plurality of interested parties. Criteria may include events and conditions which, when met, indicate that authentication should be revoked. The rules received from a plurality of interested parties may include multiple types, and in some embodiments credential engine 310 may determine criteria which include only one rule of each type. Credential engine 310 may be configured to combine rules received from a plurality of interested parties based on a priority associated with each rules. Interested parties may be any suitable source from which information associated with the client device may be received (e.g. carrier systems, financial institutions, utility companies, government organizations, universities, schools, any other suitable sources, or any combination thereof), a country in which the client device operates, any other suitable interested party, or any combination thereof.

Transaction processing circuitry 312 may be configured with any suitable software, hardwired instructions, or both to process a transaction on a client device, such as any one of client devices 1-N 106 of FIG. 1. For example, transaction processing circuitry 312 may be at least a portion of one or more integrated circuit processors. In some embodiments, transaction processing circuitry 312 may use information stored in database 304 to process a transaction. Processing a transaction may include, for example, submitting payment information, completing a sale, any other suitable process, or any combination thereof. For example, a user attempting to make a purchase transaction on a client device may be redirected from a webpage of a merchant system to a webpage associated with aggregator system 300, and transaction processing circuitry 312 may process the purchase transaction.

Request processing circuitry 314 may be configured with any suitable software, hardwired instructions, or both to process requests from other systems and devices, such as merchant system 102 of FIG. 1, carrier systems 1-N 104 of FIG. 1, and client devices 1-N 106 of FIG. 1. For example, request processing circuitry 314 may be at least a portion of one or more integrated circuit processors. Requests may include a request to output information, a request to accept information, such as a rule, a request to validate information, a request to process a transaction, any other suitable request, or any combination thereof. In some embodiments, one or more requests may be received by communication circuitry 302, and passed from communication circuitry 302 to request processing circuitry 314. Request processing circuitry 314 may determine any suitable response to each of the one or more requests, such as processing information, retrieving information, transmitting information, any other suitable response, or any combination thereof. In some embodiments, request processing circuitry 314 may be configured to process and/or respond to requests received from other circuitries within processing equipment 320. For example, request processing circuitry 314 may receive a request for information associated with a client device, and may in response retrieve information from database 304 and communicate the information to communication circuitry 302 to be output.

Data verification circuitry 316 may be configured with any suitable software, hardwired instructions, or both to verify information associated with a client device, such as any one of client devices 1-N 106 of FIG. 1. For example, data verification module 316 may be at least a portion of one or more integrated circuit processors. In some embodiments, aggregator system 300 may receive information associated with a client device from one or more sources, and data verification circuitry 316 may be configured to verify the information. In some embodiments, request processing circuitry 314 may receive a request from a merchant system to verify information associated with a client device, and data verification circuitry 316 may verify the information. Verification may include comparing received information to information stored in database 304, comparing received information to information received from one or more sources, deterministic matching, probabilistic matching, fuzzy matching, any other suitable verification technique, or any combination thereof. In some embodiments, verifying information associated with a client device may include verifying information associated with a user in possession of the client device.

Data integration circuitry 318 may be configured with any suitable software, hardwired instructions, or both to integrate information associated with a client device which is received from one or more sources. For example, data integration circuitry 318 may be at least a portion of one or more integrated circuit processors. In some embodiments, aggregator system 300 may receive information associated with a client device from one or more sources, and data integration circuitry 318 may integrate the data received from the one or more sources. Data integration may include, for example, eliminating inconsistencies between information from different sources or between information received from one source and information stored in a database (e.g., database 304), eliminating duplicate information from different sources or between information received from one source and information stored in a database (e.g., database 304), any other suitable integration technique, or any combination thereof. Sources may include interested parties such as, for example, carrier systems, financial institutions, utility companies, government organizations, universities, schools, any other suitable sources, or any combination thereof.

Ownership verification circuitry 321 may be configured with any suitable software, hardwired instructions, or both to verify ownership information for a telephone number. For example, ownership verification circuitry 321 may be at least a portion of one or more integrated circuit processors. In some embodiments, aggregator system 300 is configured to receive customer data from a merchant or from another third party source using an input (e.g., communication circuitry 302) communicatively connected to a merchant system (e.g., merchant system 102). In some embodiments, aggregator system 300 is configured to maintain its own customer data using database 304. For example, aggregator system 300 may receive customer data from merchant system 102 that includes a customer name, any other suitable customer identifier, or any combination thereof, and associated customer data for at least one customer. Customer data may include a telephone number associated with the customer name or identifier, an address associated with customer, other customer data, or any combination thereof. In some embodiments, ownership verification circuitry 321 may be configured to verify the ownership of a telephone number associated with a customer.

In some embodiments, ownership verification circuitry 321 is configured to receive real-time ownership verification data for the telephone number via an input (e.g., communication circuitry 302) that is communicatively coupled to a telephony carrier system associated with the telephone number. For example, the telephony carrier system may be one of carrier systems 1-N 104. In some embodiments, ownership verification circuitry 321 is configured to receive telephone elements data associated with the telephone number via an input (e.g., communication circuitry 302) that is communicatively coupled to the telephony carrier system. In some embodiments, ownership verification circuitry 321 is configured to determine an ownership verification score for the telephone number based on real-time ownership verification data and on the telephone elements data. In some embodiments, the ownership verification score is used by ownership verification circuitry 321 to determine whether the ownership information contained in the customer data received from a merchant is correct. In some embodiments, ownership verification circuitry 321 is configured to communicate the verification score, the determination of the correctness of the ownership information, or both to the merchant system.

In some embodiments, real-time ownership verification data includes customer name and customer address received from a telephony carrier system associated with the telephone number. Customer name data and customer address data may include real-time ownership data maintained by the telephony carrier. In some embodiments, ownership verification circuitry 321 may be configured to calculate an ownership match score by comparing the ownership verification data with customer name and associated customer data from the customer list.

In some embodiments, telephone elements data includes disconnection and port history for the telephone number. Disconnection and port history for the telephone number may include, for example, swap activities, deactivation activities, reactivation activities, suspension activities, port activities, other telephone activities, or any combination thereof associated with the telephone number. In some embodiments, the disconnection and port history is used to determine the LPRD. In some embodiments, the LPRD may be determined based on analysis of swap activities and deactivation activities associated with the telephone number. Ownership verification circuitry 321 may be configured to determine the ownership verification score based on a comparison between the last possible reassigned date and a date on which the ownership of the telephone number was last successfully verified or a date on which the customer was last successfully contacted. For example, if the last possible reassigned date is after a date on which ownership of the telephone number was last successfully verified, this may be interpreted by ownership verification circuitry 321 as an indication that ownership of the telephone number has changed.

In some embodiments, telephone elements data also includes telephone number type, (e.g. whether the telephone number is mobile or a landline). In some embodiments, telephone elements data also includes account level details, such as: status of the telephone (e.g., active/canceled), and the type of telephone (e.g., prepaid/postpaid), other account level data, or any combination thereof. In some embodiments, ownership verification circuitry 321 is configured to determine the ownership verification score based on the disconnection and port history for the telephone number, telephone number type, and account level details. In some embodiments, ownership verification circuitry 321 is configured to determine telephone elements score based on the telephone elements data.

In some embodiments, ownership verification circuitry 321 is configured to determine the ownership verification score based on telephone number ownership data obtained from public sources and based on telephone lookup service response data (e.g., ENUM data). In some embodiments, the ownership verification score is calculated as a weighted sum or weighted average of two or more of ownership score, telephone elements data score, and other ownership scores calculated based on public sources data or telephone lookup response data. In some embodiments, ownership verification score is calculated based on the aforementioned scores using any other suitable technique.

Reassignment tracking circuitry 322 may be configured with any suitable software, hardwired instructions, or both to perform reassignment tracking for a telephone number. For example, reassignment tracking circuitry 322 may be at least a portion of one or more integrated circuit processors. In some embodiments, reassignment tracking circuitry 322 is configured to track reassignments for a telephone number which ownership was verified by ownership verification circuitry 321. In some embodiments, reassignment tracking circuitry 322 is configured to track reassignments for any requested telephone number. In some embodiments, reassignment tracking circuitry 322 is configured to perform reassignment tracking based on telephone elements data for the telephone number received from a telephony carrier (e.g., one of carrier systems 1-N 104). In some embodiments, reassignment tracking circuitry 322 is configured to perform reassignment tracking based on telephone lookup service response data (e.g., ENUM data) provided by a telephony carrier system or by another data source. In some embodiments, reassignment tracking circuitry 322 is configured to determine that a reassignment of the telephone number has occurred by analyzing at least one of swap activity data, suspension activity data, deactivation activity data, and reactivation activity data associated with the telephone number. In some embodiments, reassignment tracking circuitry 322 is configured to determine that no reassignment has occurred and continue tracking the telephone number. In some embodiments, reassignment tracking circuitry 322 is configured to determine that a reassignment has occurred and discontinue tracking. In some embodiments, reassignment tracking circuitry 322 is configured to transmit result of the reassignment tracking to a merchant system (e.g., merchant system 102) or to another third party.

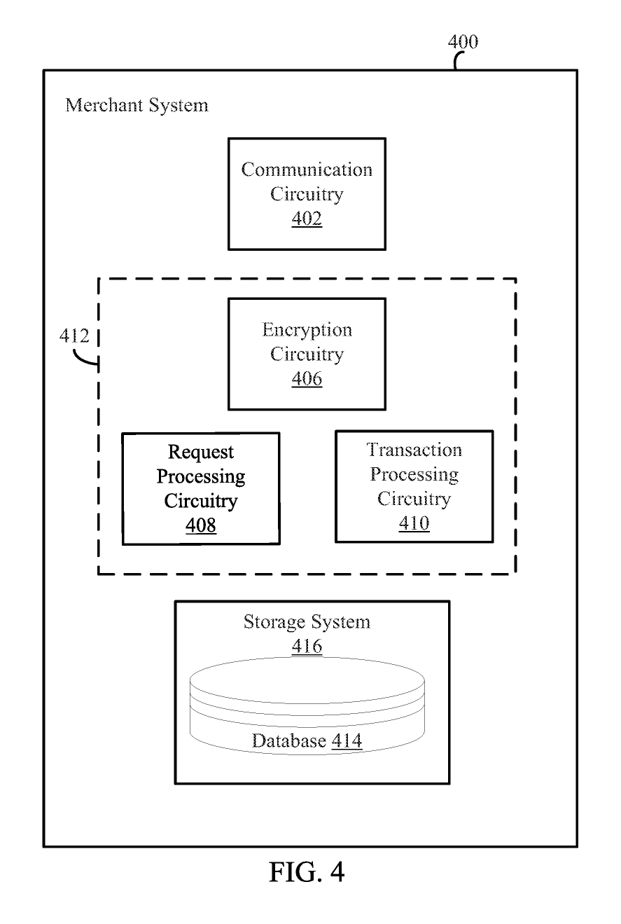

FIG. 4 is a block diagram of illustrative merchant system 400 in accordance with some embodiments of the present disclosure. Merchant system 400 may be any suitable merchant system, for example, merchant system 102 of FIG. 1 or merchant system 204 of FIG. 2. In some embodiments, merchant system 400 is implemented in a network environment, such as that of FIG. 1. Merchant system 400 may include any suitable software, hardware, or both configured to implement the features as described herein. For example, merchant system 400 may include server hardware and software. Merchant system 400 may include communication circuitry 402, storage system 416, and processing equipment 412.

Communication circuitry 402 may be configured with any suitable software, hardwired instructions, or both to communicate with database 414 and processing equipment 412, and may include inputs, outputs, any other mechanisms which facilitate communication with other systems and devices, or any combination thereof. An input or output is a relative communication channel that can be used to receive or send data, respectively. A communication channel may be established as, for example, an IP protocol-based communications session using any suitable network infrastructure, including the Internet, any proprietary LAN, WAN, any other suitable network infrastructure, or any combination thereof. Inputs and outputs can be implemented as one or more physical ports, a data storage device, any other suitable hardware interface, software interface, or any combination thereof. For example, merchant system 400 may include a carrier input coupled to a carrier system (e.g., one of carrier system 1-N 104) and configured to receive data from the carrier system, a carrier output coupled to the carrier system and configured to output data to the carrier system, an aggregator input coupled to an aggregator system and configured to receive data from the aggregator system, an aggregator output coupled to the aggregator system and configured to output data to the aggregator system, a client device input coupled to a client device and configured to receive data from the client device, a client device output coupled to the client device and configured to output data to the client device, any other suitable input or output, or any combination thereof. In the context of the present disclosure, it may be preferential for merchant system 400 to not include a carrier input and a carrier output. That is, merchant system 400 need not be able to communicate with a carrier system in preferred embodiments of the present invention. While different inputs and outputs are described, it will be understood that they need not be separate components and two or more of the inputs and/or outputs may, indeed be implemented as a single component that can be used to send or receive data relative to more than one destination or source, respectively. For example, communication circuitry 402 may include a transceiver, such as an Ethernet card, or any other suitable device or circuitry which facilitates communication with other systems and devices.

Storage system 416 may include any suitable hardware, software, or both for implementing an organized data storage system capable of storing one or more databases and information related to, for example, merchant data, client device data, user data, authentication, rules, and carrier data. For example, storage system 416 may include database 414. In some embodiments, storage system 416 may store information which is not stored in database 414, such as information related to merchant data, for example APIs, HTML for content pages, any other suitable information, and any combination thereof. In some embodiments, merchant system 400 may be configured to communicate any information stored in storage system 416 or in database 414 to a trusted aggregator system, such as aggregator system 300.

Database 414 may include any suitable hardware, software, or both for implementing an organized data storage system capable of storing information related to, for example, merchant data, client device data, user data, and carrier data. Information related to merchant data may include, for example, SKUs related to goods for sale, customer service contact information (e.g., a telephone number, an email address, a hyperlink for a website), payload information, data related to criteria for revoking authentication, any other merchant data, or any combination thereof. Information related to client device data may include, for example, a mobile device number, identification information associated with a client device, any other client device data, or any combination thereof. Information related to user data may include, for example, authentication information for an authenticated user, credential information for an authenticated user, any other user related information, or any combination thereof. Carrier data may include, for example, the carrier network associated with a client device. In some embodiments, database 414 may store information in an encrypted form. For example, hashed information may be generated using a hash operation, and the hashed information may be stored in database 414.

In some embodiments database 414 may include a customer list. A customer list may, for example, include a list of customers with associated customer data. Customer data may include a telephone number, telephone number type (e.g., mobile, landline, worked, home), customer address, any other relevant user information, or any combination thereof. Merchant System 400 may be configured to communicate some or all of the customer data to aggregator system, such as aggregator system 300 of FIG. 3, for ownership verification and reassignment tracking. Merchant System 400 may update database 414 based on data received from the aggregator system. For example, customer data may be removed or updated based on the result of ownership verification and/or reassignment tracking performed by the aggregator system.

Processing equipment 412 may be any suitable hardware, software, or both configured to process data received from other systems and devices (e.g., a client device, an aggregator system, or any other suitable system or device), process data to be output to other systems and devices, generate data, analyze data (e.g., confirm authentication information provided by a client device), and perform other tasks. In some embodiments, processing equipment 412 may include one or more circuitries for performing the functionality as described herein, such as encryption circuitry 406, request processing circuitry 408, transaction processing circuitry 410, any other suitable processing equipment, or any combination thereof. The circuitries within processing equipment 412 may communicate with one another to implement the features described herein. Additionally, the circuitries within processing equipment 412 may all be implemented together on one or more devices. Processing equipment 412 may communicate with communication circuitry 402 and database 414 to retrieve and/or transmit information. For example, processing equipment 412 may retrieve credential information associated with a user in possession of a client device from database 414 before allowing a transaction to be made on the client device.

Encryption circuitry 406 may be configured with any suitable software, hardwired instructions, or both to encrypt, decrypt, or both information such as, for example, a payload, information to be stored in database 414, any other suitable information, or any combination thereof. For example, encryption module 406 may be at least a portion of one or more integrated circuit processors. Encrypting information may protect the information from being stolen, hacked, or otherwise leaked to a source which does not have permission to access the information. In some embodiments, information may be encrypted using an encryption key, such as a symmetric key, an asymmetric key, any other suitable encryption method, or any combination thereof. For example, an aggregator system may provision a merchant system with an encryption key, and the merchant system may use the encryption key to encrypt information. In some embodiments, the advanced encryption standard (AES), or any other suitable strong symmetric-key block cipher, should be used when information is encrypted by encryption circuitry 406. Merchant system 400 may pass a payload encrypted by encryption circuitry 406 to a client device, and the encrypted payload may facilitate client-initiated interaction between a client device and an aggregator system. An encrypted payload may be unique for a client device, but not unique for each request made by the client device.

Request processing circuitry 408 may be configured with any suitable software, hardwired instructions, or both to process requests from other systems and devices, for example, from carrier systems 1-N 104 of FIG. 1, from aggregator system 100 of FIG. 1, or from any one of client devices 1-N 106 of FIG. 1. For example, request processing circuitry 408 may be at least a portion of one or more integrated circuit processors. Requests may include a request to output information (e.g., identification information or authentication information), a request to accept information, any other suitable request, or any combination thereof. In some embodiments, one or more requests may be received by communication circuitry 402 and passed from communication circuitry 402 to request processing circuitry 408. Request processing circuitry 408 may determine an appropriate response to each of the one or more requests, for example, processing information, generating information, analyzing information, communicating with another circuitry within processing equipment 412, transmitting data to database 414, receiving data from database 414, any other appropriate response, or any combination thereof. In some embodiments, request processing circuitry may process, respond to, or both, requests received from other circuitries within processing equipment 412.

Transaction processing circuitry 410 may be configured with any suitable software, hardwired instructions, or both to process a transaction made on a client device. For example, transaction processing circuitry 410 may be at least a portion of one or more integrated circuit processors. Processing a transaction may include, for example, submitting payment information, completing a sale, any other suitable process, or any combination thereof. A transaction may be a purchase transaction, a registration, any other suitable process, or any combination thereof. In some embodiments, transaction processing circuitry 410 may use data stored in database 414 to process a transaction. In other embodiments, transaction processing circuitry 410 may use data received from another system, such as an aggregator system, to process a transaction. For example, a client device may visit a website published by merchant system 400 to make a purchase transaction, and merchant system 400 may receive information from an aggregator system, such as aggregator system 100 of FIG. 1, to process the purchase transaction. In some embodiments, transaction processing circuitry 410 may pre-populate transaction data fields with information received from another system or device, or information received from database 414.

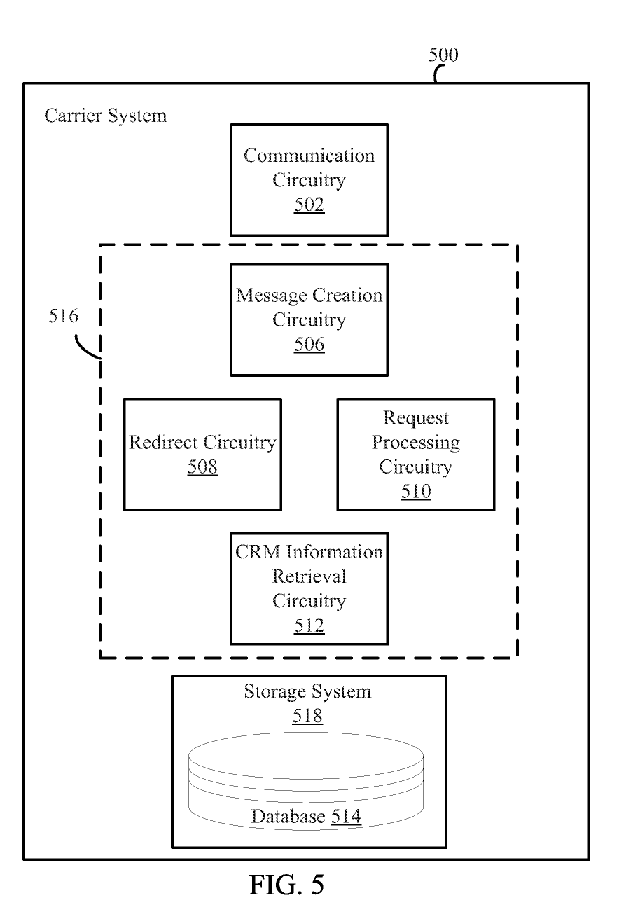

FIG. 5 is a block diagram of illustrative carrier system 500 in accordance with some embodiments of the present disclosure. Carrier system 500 may be any suitable carrier system, such as carrier system 208 of FIG. 2 or any one of carrier systems 1-N 104 of FIG. 1. In some embodiments, carrier system 500 may be implemented in a network environment, such as that of FIG. 1. Carrier system 500 may include any suitable software, hardware, or both configured to implement the features as described herein. For example, carrier system 500 may include server hardware and software. Carrier system 500 may include communication circuitry 502, storage system 518, and processing equipment 516.

Communication circuitry 502 may be configured with any suitable software, hardwired instructions, or both to communicate with database 514 and processing equipment 516, and may include inputs, outputs, any other mechanisms which facilitate communication with other systems and devices, or any combination thereof. An input or output is a relative communication channel that can be used to receive or send data, respectively. A communication channel may be established as, for example, an IP protocol-based communications session using any suitable network infrastructure, including the Internet, any proprietary LAN, WAN, any other suitable network infrastructure, or any combination thereof. Inputs and outputs can be implemented as one or more physical ports, a data storage device, any other suitable hardware interface, software interface, or any combination thereof. For example, carrier system 500 may include an aggregator input coupled to an aggregator system and configured to receive data from the aggregator system, an aggregator output coupled to the aggregator system and configured to output data to the aggregator system, a merchant input coupled to a merchant system and configured to receive data from the merchant system, a merchant output coupled to the merchant system and configured to output data to the merchant system, a client device input coupled to a client device and configured to receive data from the client device, a client device output coupled to the client device and configured to output data to the client device, any other suitable input or output, or any combination thereof. In the context of the present disclosure, it may be preferential for carrier system 500 to not include a merchant system input and a merchant system output. That is, carrier system 500 need not be able to communicate with a merchant system in preferred embodiments of the present invention. While different inputs and outputs are described, it will be understood that they need not be separate components and two or more of the inputs and/or outputs may, indeed be implemented as a single component that can be used to send or receive data relative to more than one destination or source, respectively. For example, communication circuitry 502 may include a transceiver, such as an Ethernet card, or any other suitable device or circuitry which facilitates communication with other systems and devices.

Storage system 518 may include any suitable hardware, software, or both for implementing an organized data storage system capable of storing one or more databases and information related to, for example, account data, rules, and CRM information associated with a user in possession of a client device. For example, storage system 518 may include database 514. In some embodiments, storage system 518 may store information which is not stored in database 514, and carrier system 500 may be configured to communicate such information to a trusted aggregator system, such as aggregator system 300.

Database 514 may include any suitable hardware, software, or both for implementing an organized data storage system capable of storing information related to, for example, account data, and CRM information associated with a user in possession of a client device. CRM information may include customer data. Customer data may include a telephone number, telephone number type (e.g., mobile, landline, worked, home), customer address, any other relevant user information, or any combination thereof. In some embodiments, database 514 may also store deactivation and port history associated with telephone numbers of the customers. In some embodiments, database 514 may store information in an encrypted form. For example, hashed information may be generated using a hash operation, and the hashed information may be stored in database 514.

Processing equipment 516 may be any suitable hardware, software, or both configured to process data received from other systems and devices (e.g., a client device, an aggregator system, or any other suitable system or device), process data to be output to other systems and devices (e.g., CRM information), and perform other tasks. In some embodiments, processing equipment 516 may include one or more circuitries for performing the functionality as described herein, such as request processing circuitry 510, CRM information retrieval circuitry 512, any other suitable processing equipment, or any combination thereof. The circuitries within processing equipment 516 may communicate with one another to implement the features as described herein. Additionally, the circuitries within processing equipment 516 may all be implemented together on one or more devices. Processing equipment 516 may be configured to communicate with communication circuitry 502 and database 514 to retrieve and/or transmit information related to user account data, CRM information, any other information, or any combination thereof.

Request processing circuitry 510 may be configured with any suitable software, hardwired instructions, or both to process requests from other systems and devices, for example, aggregator system 100 of FIG. 1 or any one of client devices 1-N 106 of FIG. 1. For example, request processing circuitry 510 may be at least a portion of one or more integrated circuit processors. Requests may include a request for information, CRM information, any other suitable request, or any combination thereof. In some embodiments, CRM information includes customer data. In some embodiments, customer data includes real-time telephone number ownership information. Requests may include a request for deactivation and port history for a telephone number. One or more requests may be received by communication circuitry 502 and passed from communication circuitry 502 to request processing circuitry 510. Request processing circuitry 510 may determine a suitable response to each of the one or more requests, such as processing information, communicating with another circuitry within processing equipment 516, transmitting data to database 514, receiving data from database 514, any other appropriate response, or any combination thereof. In some embodiments, request processing circuitry 510 may process, respond, or both to requests received from other circuitries within processing equipment 516.

In some embodiments, request processing circuitry 510 is configured to process request for real-time telephone number ownership information. Processing circuitry 510 may also be configured to process request for disconnection and port history data. Processing circuitry 510 may also be configured to process requests for telephone lookup services information, such as ENUM.

CRM information retrieval circuitry 512 may be configured with any suitable software, hardwired instructions, or both to retrieve CRM information associated with a client device. For example, CRM information retrieval circuitry 512 may be at least a portion of one or more integrated circuit processors. In some embodiments, CRM information may include information related to an account associated with a user in possession of a client device (e.g., payment information, name, address, social security number, etc.), or any other suitable information which may be obtained through interactions between carrier system 500 and a client device. It should be understood that protected information associated with a user, such as a social security number, may only be accessed by trusted systems and devices to which permission has been granted by the user. CRM information retrieval circuitry 512 may be configured to retrieve appropriate CRM information from database 514. In some embodiments, CRM information retrieval circuitry 512 may be configured to retrieve appropriate CRM information in response to a request received from request processing circuitry 510. For example, an aggregator system, such as aggregator system 100 of FIG. 1, may request CRM information associated with an identified client device from carrier system 500, and CRM information retrieval circuitry 512 may retrieve the requested CRM information and provide it to communication circuitry 502 to be output to the aggregator system.

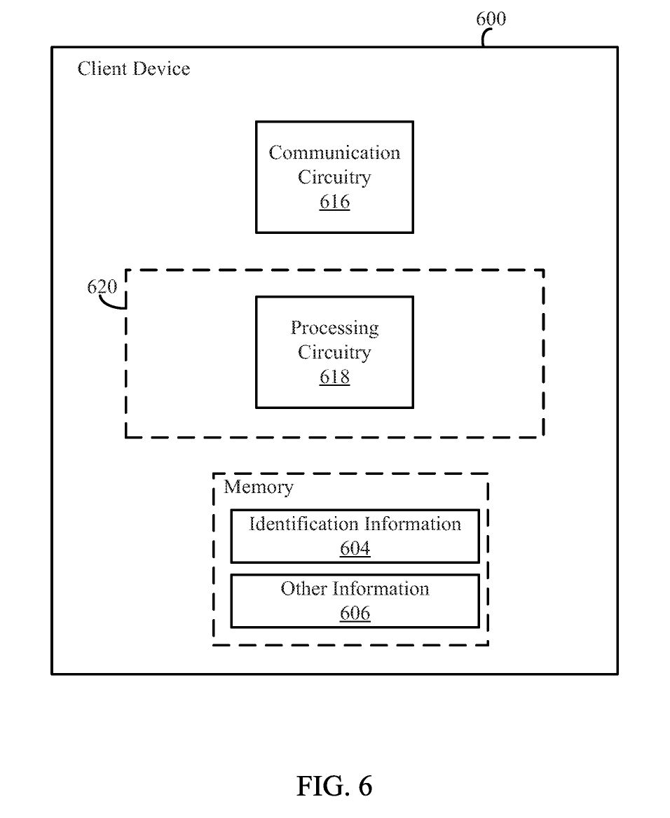

FIG. 6 is a block diagram of illustrative client device 600 in accordance with some embodiments of the present disclosure. Client device 600 may be any suitable client device, such as client device 206 of FIG. 2 or any one of client devices 1-N 106 of FIG. 1. In some embodiments client device 600 may be implemented in a network environment, such as that of FIG. 1. Client device 600 may include any suitable software, hardware, or both configured to implement the features as described herein. Client device 600 may include: communication circuitry 616, memory 608, and processing equipment 620.

Communication circuitry 616 may include inputs, outputs, any other mechanisms which facilitate communication with other systems and devices, or any combination thereof. Communication circuitry 616 may be configured with any suitable software, hardwired instructions, or both. An input or output is a relative communication channel that can be used to receive or send data, respectively. A communication channel may be established as, for example, an IP protocol-based communications session using any suitable network infrastructure, including the Internet, any proprietary LAN, WAN, any other suitable network infrastructure, or any combination thereof. Inputs and outputs can be implemented as one or more physical ports, a data storage device, any other suitable hardware interface, software interface, or any combination thereof. For example, client device 600 may include a carrier input coupled to a carrier system and configured to receive data from the carrier system, a carrier output coupled to the carrier system and configured to output data to the carrier system, a merchant input coupled to a merchant system and configured to receive data from the merchant system, a merchant output coupled to the merchant system and configured to output data to the merchant system, an aggregator input coupled to an aggregator system and configured to receive data from the aggregator system, an aggregator output coupled to the aggregator system and configured to output data to the aggregator system, any other suitable input or output, or any combination thereof. While different inputs and outputs are described, it will be understood that they need not be separate components and two or more of the inputs and/or outputs may, indeed be implemented as a single component that can be used to send or receive data relative to more than one destination or source, respectively. For example, communication circuitry 616 may include a transceiver, such as an Ethernet card, or any other suitable device or circuitry which facilitates communication with other systems and devices. Communication circuitry 616 may be configured to communicate with memory 608 and processing equipment 620.

Memory 608 may be one or more suitable memory devices such as, for example, a hard disk drive, flash memory, random access memory (RAM), an optical disk, any other suitable memory device, or any combination thereof. Memory 608 may include identification information 604 and other information 606. Identification information 604 may include any suitable identification information related to client device 600. For example, identification information 604 may include information identifying hardware or software of client device 600, information identifying a mobile telephone number associated with client device 600, information identifying a device model of client device 600, information identifying a user in possession of client device 600, information identifying a carrier system associated with client device 600, any other suitable identification information, or any combination thereof. Other information 606 may include any information stored in memory 608 other than identification information 604. For example, other information 606 may store information related to applications, messaging, photos and videos, transactions, merchants, networks, capacity and storage, any other suitable information, or any combination thereof.

Processing equipment 620 may be any suitable hardware, software, or both configured to process data received from other systems and devices (e.g., a merchant system, a carrier system, an aggregator system, or any other suitable system or device), process data to be output to other systems and devices, process data related to mobile applications, and perform other tasks. In some embodiments, processing equipment 620 may include processing circuitry 618, any other suitable processing equipment, or any combination thereof.

Processing circuitry 618 may be configured with any suitable software, hardwired instructions, or both to implement any client device features. For example, processing circuitry 618 may be configured to run applications, to compute information, to process instructions, to carry out functions related to client device operation, to carry out any other suitable operation or implementation, or any combination thereof.

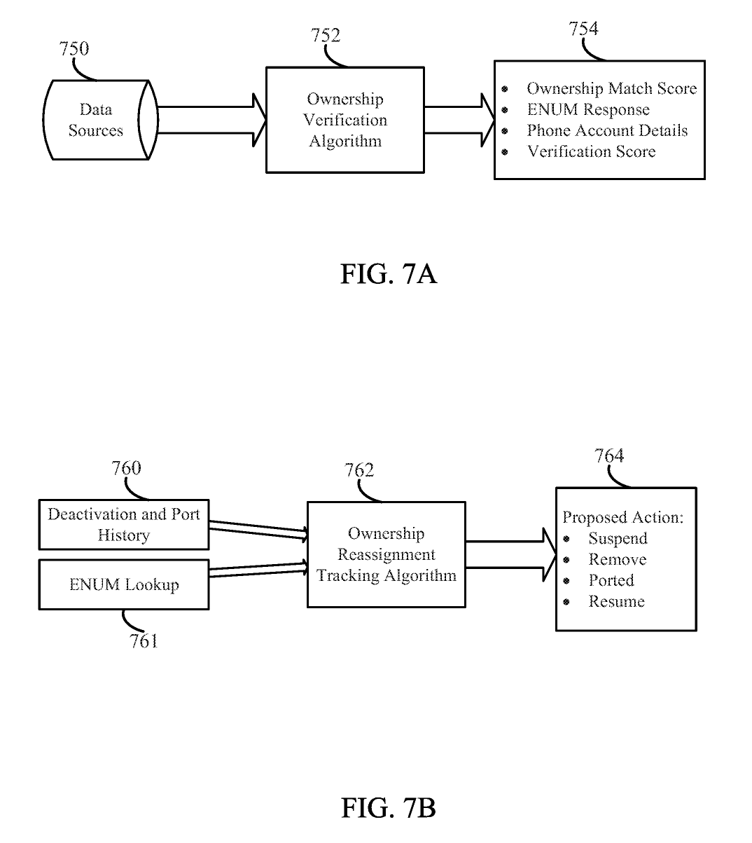

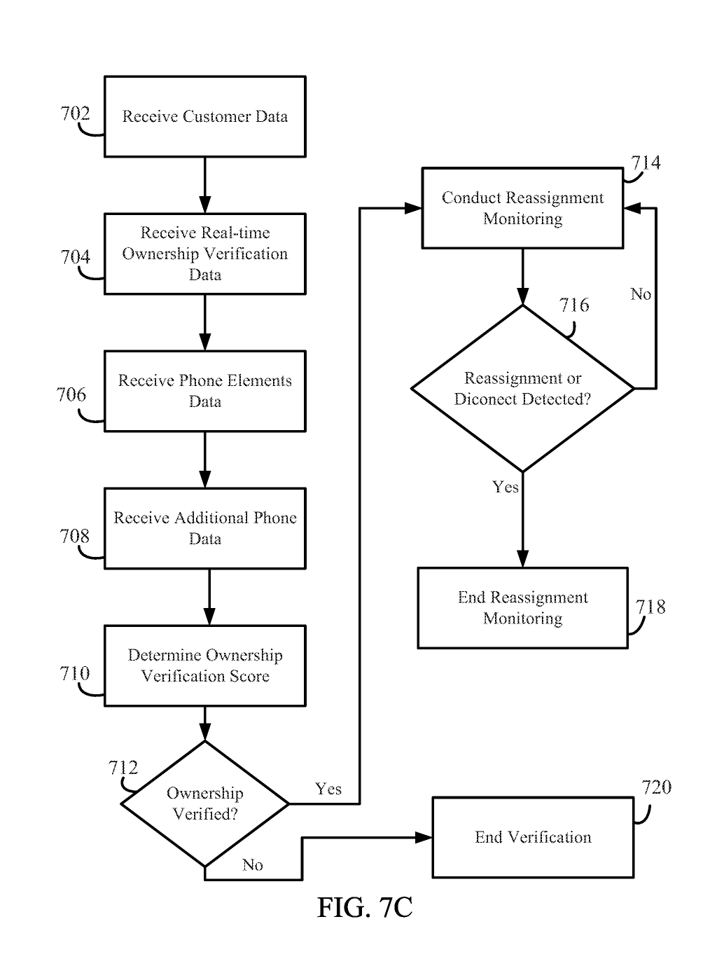

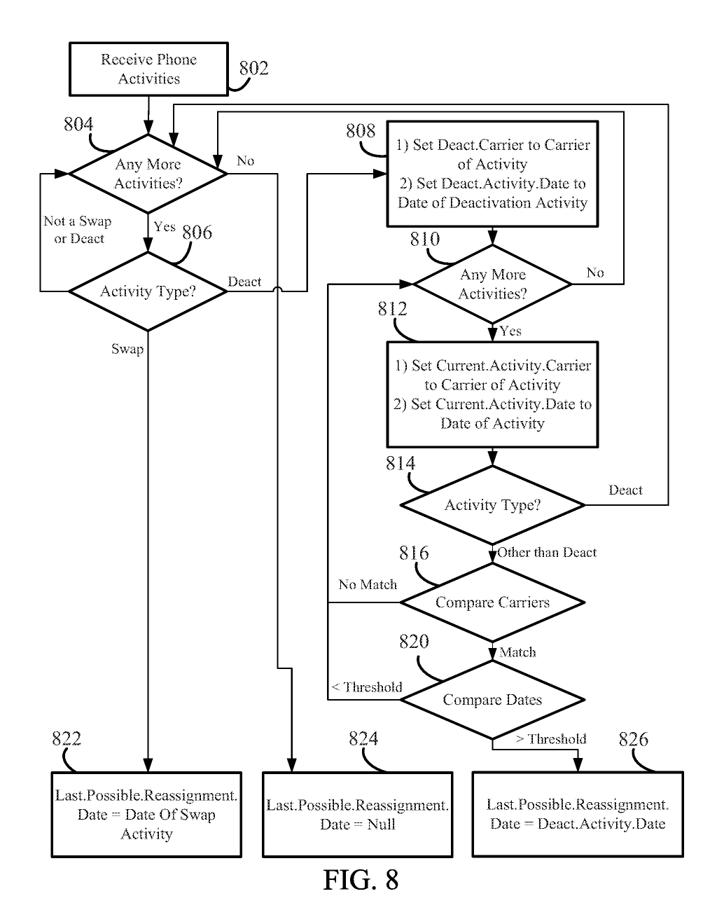

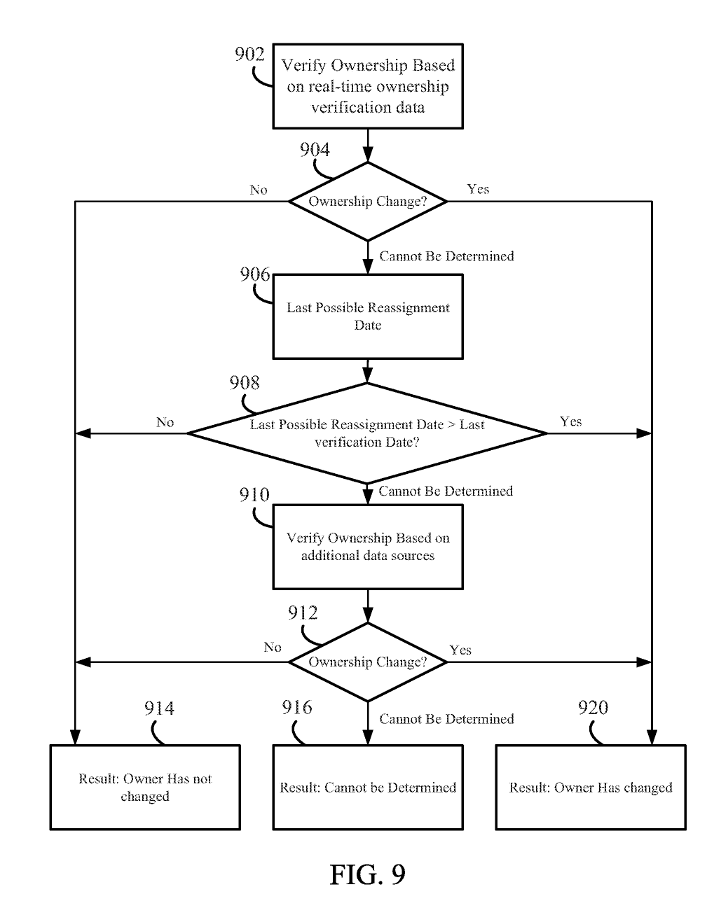

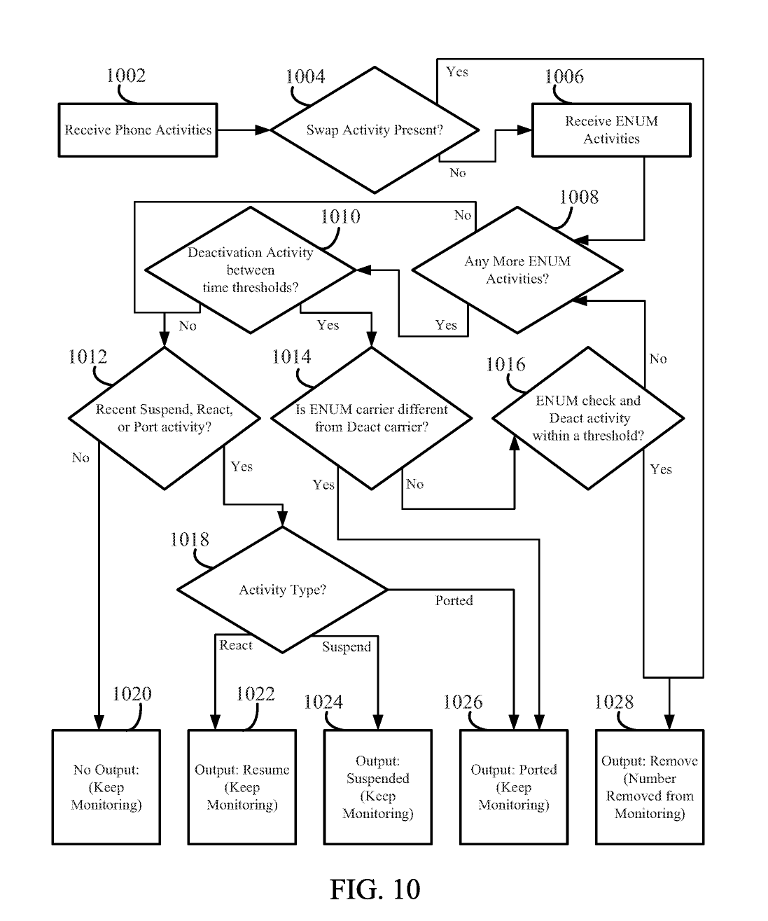

The following discussion will focus on an implementation of the system discussed with respect to FIGS. 1-6 in which an aggregator is configured to verify ownership of a telephone number and to perform reassignment tracking for a telephone number. For example, an aggregator may verify ownership of a telephone number listed in a customer data received by the aggregator from a merchant and conduct telephone number reassignment tracking. FIG. 7A, for example, is a block diagram showing an illustrative data flow as part of a telephone number ownership verification process. This process may be performed by an aggregator (e.g., aggregator system 100, 202, or 300). FIG. 7B, for example, is a block diagram showing an illustrative data flow as part of a telephone number reassignment tracking process. This process may be performed by an aggregator (e.g., aggregator system 100, 202, or 300). FIG. 7C, for example, shows a more detailed flow chart of illustrative steps performed by an aggregator (e.g., aggregator system 100, 202, or 300) as part of a telephone number ownership verification and telephone number reassignment tracking. FIG. 8 shows a flow chart of illustrative steps that are performed, in some embodiments, by an aggregator (e.g., aggregator system 100, 202, or 300) as part of the process shown in FIG. 7C, for example, as a part of determining last possible reassignment date. FIG. 9 shows a flow chart of illustrative steps that are performed, in some embodiments, by an aggregator (e.g., aggregator system 100, 202, or 300) as part of the process shown in FIG. 7C, for example, as a part of determining a verification score. FIG. 10 shows a flow chart of illustrative steps that are performed, in some embodiments, by an aggregator system (e.g., aggregator system 100, 202, or 300) as part of the process shown in FIG. 7C, for example, as a part of conducting reassignment tracking for a telephone number.

Referring to FIG. 7A, at block 750, an aggregator receives data from data sources. In some embodiments, the aggregator accumulates data from different sources in order to perform telephone number ownership verification and to track telephone number ownership reassignments. The aggregator uses at least one of the following data sources: real-time (up to the second) ownership data from telephony carriers, telephone number ownership data from public sources, disconnection and port history from telephony carriers, and telephone lookup service responses from telephony carriers. The aggregator may have unique connections with all the major telephony carriers that allow the aggregator to access live ownership data for a telephone number directly from the telephony carriers. The data received from telephony carriers may include account level information and personally identifiable information (PII). In some embodiments, the aggregator also sources ownership data from publicly available and other sources to augment the ownership verification and tracking of telephone number reassignment. In some embodiments, the aggregator also uses disconnection and port history from the telephony carriers for the purpose of tracking number reassignment to another subscriber and for ownership verification. In some embodiments, the aggregator also uses telephone lookup service responses (e.g., ENUM responses) to augment the data sources already being utilized for ownership verification and reassignment tracking.

At block 752, the aggregator uses all the different data sources mentioned at block 750 to perform telephone number ownership verification. For example, the aggregator may accept customer data from a merchant system for performing ownership verification. There are varying degrees of confidence with which ownership verification can be performed by the aggregator. In some embodiments, the ownership verification process depends on the content of the customer data. The aggregator uses a complex algorithm to perform ownership verification described below in more detail. The algorithm includes the calculation of an ownership match score, calculation of telephone elements score based on a LPRD, and a use of rules to determine the ownership confidence.

In some embodiments, the ownership verification process includes performing a validation of the telephone number ownership based on the name and address information received from telephony carriers. In some embodiments, the ownership verification also takes into account additional data elements, such as account level telephone data from telephony carriers for the telephone number. In some embodiments, the ownership verification process includes determining an overall ownership verification score computed using all available data that is indicative of confidence of telephone number ownership. The ownership verification process may include matching first and last name included in the customer data against first and last name provided by the telephony carriers. In some embodiments, the ownership verification process includes matching an address included in the customer data against an address provided by the telephony carriers. In some embodiments, the ownership verification process includes analyzing telephone elements data. For example, disconnection and port history may be evaluated to deduce a LPRD and to compare the LPRD with date on which the telephone number was last successfully contacted. In another example, telephone number type may be analyzed to identify if the telephone number is a mobile or landline number. In yet another example, account level details such as the status of the telephone number (e.g., active/cancelled) and the type of the telephone number (e.g., prepaid/postpaid) are retrieved and analyzed.

The aggregator may use the aforementioned techniques to determine an ownership verification score. For example, an overall ownership verification score that indicates the probability of correctness of ownership information for a particular telephone number may be computed for the telephone number in the customer data. This ownership verification score may be calculated using the values from an ownership match score and from a telephone elements score determined based on telephone elements data.

At block 754, the aggregator produces several outputs. The outputs include at least some of the following information: 1) ownership match score; 2) ENUM response; 3) telephone account details score; and 4) ownership verification score.

Referring to FIG. 7B, an aggregator tracks telephone number ownership reassignment for telephone numbers that are placed in tracking after telephone number ownership verification of those number or through direct entry into a tracking queue. In some embodiments, the tracking queue contains all telephone numbers that are currently getting tracked for ownership reassignment. In some embodiments, for each telephone number in the tracking queue, the aggregator performs the steps described below.

At block 760, an aggregator receives port and deactivation history for a telephone number. At block 761, the aggregator receives ENUM response data for the telephone number.

At block 762, the aggregator checks the deactivation and port history to identify if there are any changes to the status of the telephone number and uses the ENUM response data to identify port changes. This combined check may be done on a daily basis for all the telephone numbers in the tracking queue.

At block 764, if there are any changes to the status of the telephone number, the aggregator informs the merchant system of the suggested action. In some embodiments, the aggregator recommends at least one of the following actions to the merchant system: suspend, remove, ported, resume. Suspend recommendation may indicate that the telephone number, was temporarily suspended by a telephony carrier, and that the merchant should not make any calls while the telephone number is suspended. Remove recommendation may indicate that the ownership of the telephone number has changed, and that the merchant system should remove that telephone number from the customer data. Ported recommendation may indicate that the telephone number was ported by the customer to another telephony carrier. Resume recommendation, may indicate that merchant may resume contacting the customer using the telephone number.

Referring to FIG. 7C, at step 702, an aggregator receives customer data for telephone number ownership verification. In some embodiments, customer data is received from a merchant (e.g., merchant system 102, 204, or 400). While the disclosure is described in the context of a merchant system, it will be understood that a system associated with any other suitable entity can use the aggregator system to verify telephone numbers. Such entities may include educational institutions, financial institutions, government authorities, non-profit organizations, or any other organizations that maintain customer data. Customer data may contain a user name, user address, user's telephone number, user's telephone number type (e.g., mobile or landline), any other customer data, or any combination thereof. In some embodiments, the aggregator may receive customer data from one or more other sources, for example from public data sources (e.g., public data sources 110, 220), proprietary databases, or via manual data entry.

At step 704, the aggregator receives real-time ownership data from a telephony carrier system associated with the user's telephone number. In some embodiments, the aggregator receives the real-time ownership data in response to a request send by the aggregator. For example, the aggregator may send such a request to at least one of carrier systems 1-N 104, or carrier system 208. In some embodiments, real-time ownership data is received from one of carrier systems 1-N 104, or carrier system 208. Real-time ownership data may include current name and address information associated with the telephone number. In some embodiments, the aggregator system has access to multiple carrier systems (e.g., carrier systems 1-N 104), and queries several carrier systems until the real-time ownership data is received. In some embodiments, ownership data may be correct up to a second. In some embodiments, ownership data may include account level information and personally identifiable information (PII).

At step 706, the aggregator receives telephone elements data from a telephony carrier system associated with the user's telephone number. In some embodiments, the aggregator receives telephone elements data in response to a request send by the aggregator. For example, the aggregator may send such a request to at least one of carrier systems 1-N 104, or carrier system 208. In some embodiments, telephone elements ownership data is received from one of the carrier systems 1-N 104, or carrier system 208. In some embodiments, telephone elements data may include disconnection and port history for the telephone number, telephone number type information (e.g., mobile or landline), account level details such as the status of the telephone (active/cancelled) and the type of telephone (prepaid/postpaid), or any combination thereof.

At step 708, the aggregator receives additional data that is used to perform ownership verification. In some embodiments, the aggregator receives additional data in response to a request send by the aggregator. For example, the aggregator may send such a request to at least one of carrier systems 1-N 104, or carrier system 208 and/or to public data sources, such as public data sources 110. In some embodiments, the aggregator may receive telephone number ownership data from publicly available sources (e.g., public data sources 110). In some embodiments, publicly available sources may include Lexis Nexis™, NuStar™, other public data sources, or any combination thereof. In some embodiments, the aggregator may receive data from a telephone lookup service responses (e.g., ENUM responses). Telephony lookup service response data may be provided by the telephony carrier system or by any other source.

At step 710, the aggregator determines ownership verification score. In some embodiments, the ownership verification score may be indicative of confidence of ownership of the telephone number by the customer listed in the customer data. The verification score may be based on real-time ownership data received at step 702, telephone elements data received at step 706, additional data received at step 708, or any combination thereof. For example, the ownership verification score may be based on an ownership match score, telephone elements score, additional scores, or any combination thereof. In some embodiments, the verification score is a weighted sum, or weighted average of the ownership match score, telephone elements, additional scores, or any combination thereof.

In some embodiments, an ownership match score is determined by the aggregator by comparing name and address information contained in the ownership data received at step 704 against name and address information contained in customer data received at step 702. In some embodiments, a perfect match results in a high ownership match score, while partial matches result in a lower ownership match score. In some embodiments, an ownership match score is determined based on a separately determined score for a name match, and a separately determined score for an address match.

In some embodiments, telephone elements score may be based on analysis of disconnection and port history for the telephone number. For example, a Last Possible Reassignment Date (LPRD) may be determined based on activities present in the reassignment and port history. LPRD may indicate the last possible date on which the telephone number was reassigned. For example, if the aggregator determines that that the telephone number was swapped by the customer, that is the customer exchanges his number for a different number provided by the same carrier, the aggregator determines LPRD to be the date of that swap. In another example, if the aggregator determines that that the telephone number was reassigned to a different customer, the aggregator determines LPRD to be the date of the reassignment.

In some embodiments, LPRD is compared to a date on which customer data received at step 702 was last verified or to a date on which the customer was last successfully contacted. For example, LPRD predating the last verified date may result in a high telephone elements score, while LPRD postdating the last verified date may result in a low telephone elements score. In some embodiments, telephone elements score may also be based on matching telephone number type information received at step at step 706 with customer data received at step 702. In some embodiments, telephone elements score may also be based on account level details received at step 706.

In some embodiments, additional scores are computed by the aggregator based on ownership data received from public sources received at step 708. For example, some additional scores are computed by comparing ownership data from public sources with customer data provided by customer data received at step 702. In some embodiments, some additional scores are computed based on data acquired from a telephone lookup service responses at step 708.

At step 712, the aggregator determines if the ownership of the telephone number is verified. In some embodiments, ownership is considered to be verified if the ownership verification score exceeds a pre-defined threshold. In some embodiments, ownership verification or failure of verification is determined completely by ownership match score. For example a perfect match between real-time ownership verification data and customer data may result in immediate ownership verification of the telephone number. In some embodiments, ownership verification or failure of verification is determined completely by telephone elements data. For example LPRD postdating the last verified date may result in immediate conclusion that ownership of the telephone number has changed. If the ownership of the telephone number is considered to be verified, the aggregator may proceed to step 714. If the ownership of the telephone number is considered to be not verified (e.g., if the aggregator has determined that ownership of the telephone number has changed), the aggregator may proceed to step 720. In some embodiments, the aggregator can report the outcome of the telephone number verification to the merchant system (e.g., merchant system 102). In some embodiments, the aggregator may recommend an action to the merchant system. For example, actions include, for example, removing the telephone number from a customer data due to a telephone number reassignment, and suspending a number from a contact data because of a temporary suspension of the telephone account by a telephony carrier.

At step 720, the aggregator may end the verification process by concluding that ownership of the telephone number has changed. In some embodiments, the aggregator may edit the customer data accordingly. For example, the aggregator removes the unverified telephone number from the customer data, or marks the telephone number from the customer data as “unverified.” In some embodiments, the aggregator may forward the edited customer data to the merchant or to another third party.

At step 714, the aggregator conducts reassignment tracking for a telephone number that has been verified. In some embodiments, reassignment tracking is less computationally intensive than ownership verification. This is important for large customer databases, where full verification of an entire list of customers is too computationally demanding. In some embodiments, if a full telephone number ownership verification was performed at least once, the aggregator no longer needs to perform full telephone number ownership re-verification again for that telephone number. Instead, the aggregator may conducting telephone number reassignment tracking to ensure continued correctness of the telephone number ownership information. Performing reassignment tracking instead of full telephone number ownership verification provides further improvements to operation of the aggregator by allowing the aggregator to operate more efficiently. In some embodiments, the aggregator conducts reassignment tracking for a telephone number that has not been previously verified. For example, the telephone number can be placed into reassignment tracking by a direct request.

In some embodiments, the aggregator conducts reassignment tracking based on disconnection and port history from telephony carriers and based on information from a telephone lookup service (e.g., ENUM). In some embodiments, the aggregator analyzes the disconnection and port history and ENUM responses to determine whether the telephone number was reassigned or disconnected. In some embodiments, the aggregator analyzes the disconnection and port history covering a pre-defined period of time. For example, 24 hours of disconnection and port history may be analyzed by the aggregator at a time. In some embodiments, any other pre-defined or adjustable time period is used by the aggregator.

At step 716, the aggregator analyzes the output of reassignment tracking performed at step 714. If the reassignment tracking did not detect reassignment or disconnections associated with the telephone number, the aggregator may continue conducting reassignment tracking at step 714. For example, step 714 may be performed later with a more up-to-date disconnect and port history. In some embodiments, the aggregator performs step 714 every 24 hours. In some embodiments, step 714 is performed by the aggregator once during every pre-defined or adjustable time period. In some embodiments, if the reassignment tracking detects reassignment or disconnection associated with the telephone number, the aggregator then determines that ownership of the telephone number has changed and continue to step 718.

In some embodiments, at step 718, the aggregator discontinues reassignment tracking of a telephone number. In some embodiments, the aggregator also edits the customer data accordingly. For example, the aggregator may remove the reassigned or disconnected telephone number from the customer data, or mark the telephone number from the customer data as “reassigned” or “disconnected.” In some embodiments, the aggregator forwards the edited customer data to the merchant or to another third party.

FIG. 8 shows a detailed flow chart of a process that is used by the aggregator system, in some embodiments, to determine Last Possible Reassignment Date (LPRD). In some embodiments, this process is performed during step 710 of FIG. 7C. In some embodiments, the process depicted by FIG. 8 illustrates the aggregator looking for a scenario where the customer has given up his number and moved to a different number on the same telephony carrier (e.g., user has swapped his or her number), or a scenario where the user has deactivated his number, thereby making the number eligible for reuse by someone else. The first scenario may be detected by a presence of a swap activity. The second scenario may be detected if there was a deactivation activity on this number but after the deactivation activity the number was found to be active on the same telephone network carrier.

At step 802, the aggregator receives a list of time-stamped telephone activities. For example, the list of time-stamped telephone activities may be a part of disconnection and port history received by the aggregator at step 706. In some embodiments, the time-stamped telephone activities include swap activities, deactivation activities, reactivation activities, suspension activities, port activity, or any combination thereof.

At step 804, the aggregator starts or continues examining the received telephone activities. For example, the aggregator may start by examining the most recent telephone activity. If the most recent telephone activities was already examined, the aggregator continues with the second most recent activity, and so on. If the aggregator has determined at step, 804 that there are no more activities to be examined, the aggregator proceeds to step 824. If there are additional activities left to be examined, the aggregator proceeds to step 806 to evaluate the most recent of the remaining unexamined telephone activities.

At step 824, the aggregator sets LPRD to a “Null” value, indicative of no reassignment having occurred.

At step 806, the aggregator begins examining the most recent unexamined telephone activity by determining the type of that telephone activity. If that telephone activity is not a swap or deactivation activity, the aggregator proceeds to step 804 to examine the next telephone activity. If that telephone activity is a swap activity, that is if the customer has swapped his telephone number for another number with the same carrier, the aggregator proceeds to step 822. If that telephone activity is a deactivation activity, the aggregator proceeds to step 808.

At step 822, the aggregator sets LPRD to the date of the swap activity, indicating that the last possible reassignment occurred on the date of the swap activity. The aggregator also determines that the swap activity indicates that the user has given up his number and moved to a different number on a network provided by the same telephony carrier. In some embodiments, the aggregator evaluates the available data and determine the new number of the user. In some embodiments, the aggregator updates the customer data with the updated telephone number after the swap is detected.

At step 808, the aggregator further evaluates the deactivation activity. In some embodiments, the aggregator sets a temporary Deact.Activity.Carrier variable to the carrier listed in the deactivation activity. The aggregator also sets a temporary Deact.Activity.Date variable to the date of the deactivation activity. The aggregator then proceeds to step 810.

At step 810, the aggregator starts evaluating all activities that are more recent than the deactivation activity going forward in time. For example, the aggregator starts by examining the first telephone activity that occurred after the deactivation activity. If the first telephone activity that occurred after the deactivation activity was already examined, the aggregator continues with a second telephone activity that occurred after the deactivation activity, and so on. If there are no unexamined activities remaining, the aggregator proceeds back to step 804. If there is at least one unexamined activity remaining, the aggregator designates the activity being examined as the “current” activity and proceed to step 812.

At step 812, the aggregator begins examining the activity designated as “current.” In some embodiments, the aggregator sets a temporary Current.Activity.Carrier variable to the telephone carrier listed in the current activity. The aggregator also sets a temporary Current.Activity.Date variable to the date of the current activity. The aggregator then proceeds to step 814.

At step 814, the aggregator begins examining the “current” telephone activity by determining the type of that telephone activity. If that telephone activity is a deactivation activity, the aggregator proceeds back to step 804. If that telephone activity is an activity other than a deactivation activity, the aggregator proceeds to step 816.

At step 816, the aggregator compares the telephone carrier listed in the deactivation activity to the telephone carrier listed in the “current” activity. For example, the aggregator compares the Deact.Activity.Carrier variable to the Current.Activity.Carrier variable. If the telephone carriers match, the aggregator proceeds back to step 820. If the carriers do not match, the aggregator proceeds back to step 812.

At step 820, the aggregator compares the date of the deactivation activity and the date of the “current” activity. For example, the aggregator may subtract Deact.Activity.Date variable from Current.Activity.Date variable. If the difference between the two dates is less than a pre-defined threshold time period, the aggregator proceeds back to step 810. In some embodiments, the pre-defined threshold time period may is equal to 48 hours. In some embodiments, the 48 hours period may be used because if the telephone number was ported to a different telephony carrier by the original owner, then that number can be expected to show up on another telephony carrier almost instantly, but definitely within 48 hours. In some embodiments, a telephone number appearing on a different telephony carrier after 48 hours would indicate that the telephone number ownership has changed. In some embodiments, the pre-defined threshold may be any other pre-defined or adjustable time period. In some embodiments, if the difference between the two dates is more than a pre-defined threshold, the aggregator proceeds to step 826.

At step 826, the aggregator sets LPRD to the date of the deactivation activity, indicating that the last possible reassignment occurred on the date of the deactivation activity.

In some embodiments, at step 826, the aggregator also starts testing for a possibility that a number has been ported to a network provided by a different telephony carrier. In some embodiments, the aggregator makes periodic (e.g., daily) telephone lookup service (e.g., ENUM) requests in succession for some predetermined period of time (e.g., 3 days) following a deactivation activity. In some embodiments, the 3 day period may be used because it provides information that is recent enough to be relevant to current port activity. If the number is found on a different network operated by a different telephony carrier following the deactivation activity and within a predetermined reserve period (e.g., 30 days), the aggregator determines that telephone number has likely been ported to a different telephony carrier. In some embodiments, the 30 day period may be used because telephone carriers typically provide a 30 days grace period, during which a deactivated telephone number can still be reactivated or ported by the original owner. In some embodiments, the aggregator, at step 826, also starts testing for a possibility that a number has been reactivated. In some embodiments, the aggregator periodically examines the disconnection and port data to determine if the telephone number was re-activated by the customer. In some embodiments, the aggregator edits the customer data accordingly as the result of port tracking and/or re-activation tracking.

FIG. 9, shows a detailed flow chart of illustrative steps in a process that is used by the aggregator to determine a verification score for a telephone number present in the customer data. In some embodiments, the process for determining the verification score is performed during step 710 of FIG. 7C.

At step 902, the aggregator receive real-time ownership verification data for the telephone number from a telephony carrier (e.g., one of carriers 1-N 104). In some embodiments, the ownership data is accurate to the last second. Ownership verification data may include name and address information associated with the telephone number, account level information associated with the telephone number, personally identifiable information associated with the telephone number, or any combination thereof. The aggregator then computes an ownership match score. In some embodiments, the ownership match score is calculated by comparing name and address information contained in the customer data with name and address information from the received real-time ownership verification data. In some embodiments, name and address comparisons are weighted (e.g., the name comparison may have a greater effect on the ownership match score than the address data). In some embodiments, perfect or very good comparison match leads to an ownership match score that is more indicative of the user listed in the customer data still owning the telephone number listed in the customer data, while a poor comparison match or a total mismatch would lead to a score indicative of the user listed in the customer data no longer owning the telephone number listed in the customer data.

At step 902, the aggregator may conclude that the ownership of the telephone number is verified. For example, a match between address and name data can be an indication that the customer listed in the customer data still owns the telephone number listed in the customer data. At step 902, the aggregator may conclude that the ownership of the telephone number has changed. For example, if the address and name data in real-time ownership verification data are sufficiently different from the address and name from the customer data, the aggregator determines that the user listed in the customer data no longer owns the telephone number listed in the customer data. In some embodiments, the ownership match score may be inconclusive. For example, if the name and address data match only partially, the ownership match score may be inconclusive. In some embodiments, ownership match score is impossible to determine, because real-time ownership verification data was unavailable or was corrupted.

At step 904, the aggregator may proceed to different steps depending on the outcome of determination made at step 902. In some embodiments, if the ownership was verified, or if the ownership match score is higher than a pre-defined threshold, the aggregator proceeds to step 914. If the ownership for the telephone number was determined to have changed or if the ownership match score is lower than a pre-defined threshold, the aggregator proceeds to step 920. If the ownership verification was inconclusive, for example if the ownership match score is within predefined thresholds, or if the real-time ownership verification data was unavailable or corrupted, the aggregator proceeds to step 906.

At step 906, the aggregator determines a Last Possible Reassignment Date (LPRD) for the telephone number listed in the customer data. In some embodiments, LPRD is determined using a process such as described above in relation to FIG. 8. In some embodiments, LPRD may be determined manually, or by using other techniques. Once LPRD is determined, the aggregator proceeds to step 908.

At step 908, the aggregator compares the LPRD to a date on which the ownership of the telephone number was last verified or to a date on which the customer was last successfully contacted. In some embodiments, the aggregator creates a telephone elements score based on the comparison. For example, if the LPRD postdates the date of last verification, the aggregator sets the telephone elements score to a value indicative of the ownership being verified. In another example, if the LPRD predates the date of last verification, the aggregator sets the telephone elements score to a value indicative of the ownership of the telephone number having changed.

In some embodiments, the aggregator determines the ownership verification score based on the ownership match score and the telephone elements score. For example, the ownership verification score may be based on a weighted average of the ownership match score and the telephone elements score. In some embodiments, if the ownership verification score exceeds a certain threshold, the aggregator proceeds to step 914. In some embodiments, if the ownership verification score is below a certain threshold, the aggregator proceeds to step 920.

In some embodiments, if the LPRD predates the date of last verification, the aggregator considers the ownership to be verified and proceed to step 914. In some embodiments, if the LPRD postdates the date of last verification, the aggregator considers the ownership to be changed and proceed to step 920.

In some embodiments, the aggregator concludes that ownership verification cannot be determined. For example, if the ownership verification score is not high enough to proceed to step 920 and not low enough to proceed to step 914 the aggregator proceeds to step 910. In another example, the aggregator proceeds to step 910 if the LPRD could not be determined or was set to “Null.”

At step 908, the aggregator receives additional telephone data (e.g. additional telephone data received at step 708). For example, additional telephone data may include public telephone number ownership data receive by the aggregator from public data sources (e.g., public data sources 110). In some embodiments, the additional telephone data may include additional telephone elements data. In some embodiments, additional telephone elements data includes telephone number type (e.g. whether the telephone number is mobile or a landline). In some embodiments, telephone elements data also includes account level details, such as: status of the telephone (active/canceled), and the type of telephone (prepaid/postpaid), other account level data, or any combination thereof. In some embodiments, public telephone number ownership data includes name and address information associated with the telephone number provided by public data sources.

In some embodiments, the aggregator determines the telephone elements data score by comparing the additional telephone elements data with data listed in customer data. For example, the aggregator is configured to compare the telephone number type from the telephone elements data to telephone number type listed in customer data. In some embodiments, the aggregator is configured to modify the telephone elements data score based on the account level details. For example, account level detail indicating that the telephone number is canceled may cause the aggregator to modify the telephone elements data to be more indicative of the ownership having changed.

In some embodiments, the aggregator calculates one or more additional scores based on the additional ownership data. For example, the aggregator may calculate a public ownership match score by comparing the name and address from public ownership data to name and address listed in the customer data.

In some embodiments, the aggregator calculates an ownership verification score based on any combination of an ownership match score, telephone elements score, and any other suitable additional scores. For example, the ownership verification score may be calculated as a weighted sum or weighted average of the ownership match score, telephone elements score, and additional scores.

At step 912, the aggregator determine if the telephone number ownership change has occurred based on the ownership verification score. In some embodiments, if the ownership verification score exceeds a certain threshold, the aggregator proceeds to step 914. In some embodiments, if the ownership verification score is below a certain threshold, the aggregator proceeds to step 920. In some embodiments, if the ownership verification score is neither high enough to proceed to step 914 nor low enough to proceed to step 914, the aggregator proceeds to step 916.

At step 914, the aggregator determines that that the ownership of the telephone number listed in the customer data has not changed. In some embodiments, this determination is made because the ownership verification score is high enough to exceed a predetermined threshold. In some embodiments, the determination is made based on the determination made in step 904 or in step 908.

At step 920, the aggregator determines that that the ownership of the telephone number listed in the customer data has changed. In some embodiments, this determination is made because the ownership verification score is low enough compared predetermined threshold. In some embodiments, determination is made based on the determination made in step 904 or in step 908.

At step 916, the aggregator determines that that the ownership of the telephone number listed in the customer data cannot be determined. In some embodiments, this determination is made because the ownership verification score is neither high enough to exceed a predetermined threshold not low enough when compared to another predetermined threshold. In some embodiments, the determination is made because there was not enough data available to carry out the verification process.

In some embodiments, at each of the steps 914, 916, and 920, the aggregator edits the customer data accordingly. For example, the aggregator may change the telephone number in the customer data, mark the number as ported or suspended, or edit the customer data in any other way. In some embodiments, the aggregator can report the outcome of the telephone number ownership verification to the merchant system (e.g., merchant system 102).

FIG. 10, shows a detailed flow chart of illustrative steps in a process that is used by the aggregator to perform reassessment tracking. In some embodiments, this process is performed during step 714 of FIG. 7C. In some embodiments, the process depicted by FIG. 10 illustrates the aggregator analyzing, for example, 24 hours of disconnection and port history reported for the telephone number while looking for a scenario where the telephone number is swapped by the customer, a scenario where the telephone number was ported to a different carrier by the customer, a scenario where the ownership of the number is determined to be changed because there was a deactivation activity during a certain time period prior to the check and the telephone number was still on the network operated by the same telephony carrier within a pre-determined time, or a scenario where the telephone number was suspended. The process of FIG. 10 can be repeatedly periodically (e.g., every 24 hours while using the previous 24 hours of disconnection and port history data).

In some embodiments, the process depicted by FIG. 10 results in a determination that that the telephone number was reported as swapped (i.e., the original owner of the telephone number has swapped his telephone number for a different telephone number with the same telephony carrier). In this case, the aggregator informs the merchant system that the owner has changed and the number will no longer be tracked for ownership changes. In some embodiments, if the number was not swapped, but there was a deactivation activity at least 48 hours prior and the telephone number was still on the same telephony carrier as yesterday (as determined using an ENUM response), the ownership of the telephone number will be regarded as changed and the telephone number will be removed from further tracking. In some embodiments, the 48 hours period may be used because it is a sufficiently long time period following a deactivation, such that activity on the same telephony carrier can only be indicative of the deactivated phone number being assigned to a new owner, rather than, for example, ENUM activity being out-of-date. In some embodiments, if none of these situations apply, the telephone number is checked for presence of reactivation or suspension or port activities in the deactivation and port history. A reactivation or a port activity will lead to output results of “no change in ownership,” while a suspended activity will lead to a result of suspension of ownership. If none of the above applies, the aggregator concludes that the ownership of the telephone number has not changed and the telephone number will continue to be tracked for any ownership changes in the future.

In some embodiments, at step 1002, the aggregator receives a list of time-stamped telephone activities. For example, the list of time-stamped telephone activities may be a part of disconnection and port history received by the aggregator from at least one telephony carrier system. In some embodiments, the time-stamped telephone activities include swap activities, deactivation activities, reactivation activities, suspension activities, port activity, or any combination thereof. In some embodiments, the aggregator analyzes these time-stamped telephone activities covering a pre-defined period of time. In some embodiments, 24 hours of disconnection and port history is analyzed at a time. In some embodiments, any other pre-defined or adjustable time period may be used. In some embodiments, the step 1002 is performed by the aggregator daily, or periodically with any other frequency.

At step 1004, the aggregator determines whether the list of time-stamped telephone activities includes a swap activity. If a swap activity is present the aggregator proceeds to step 1028. If no swap activity is present the aggregator proceeds to step 1006.

At step 1006, the aggregator receive a list of ENUM activities. It is noted that while FIG. 10 refers to ENUM activities received via ENUM response, in some embodiments, activities received from a different telephone lookup service may be used in place of the ENUM activities. In some embodiments, the aggregator analyzes ENUM activities covering a pre-defined period of time. For example, 24 hours of ENUM activities are analyzed. In some embodiments, any other pre-defined or adjustable time period may be used. In some embodiments, each ENUM activity indicate that the telephone number was reported active on a certain mobile network (e.g., a network provided by one of carrier systems 1-N 104). Once ENUM activities are received, the aggregator proceeds to step 1008.

At step 1008, the aggregator starts or continues examining ENUM activities. For example, the aggregator starts by examining the most recent ENUM activity. If the most recent ENUM activity was already examined, the aggregator continues with second most recent ENUM activity, and so on. If the aggregator has determined, at step 1008, that there are no more ENUM activities to be examined, the aggregator proceeds to step 1012. If there are additional ENUM activities left to be examined, the aggregator proceeds to step 1010 to evaluate the most recent of the remaining unexamined ENUM activities.

At step 1010, the aggregator determines the date of the ENUM activity being examined. The aggregator then further analyzes the list of time-stamped telephone activities received at step 1002. In some embodiments, the aggregator determines whether a deactivation activity is present on the list of time-stamped telephone activities that is within a certain time window. For example, the aggregator may look for a deactivation activity that occurred between 48 hours and 72 before the current date. In some embodiments, the aforementioned time window may be used because it focuses the analysis on a time window that is recent enough to be relevant, yet sufficiently removed from the point of deactivation, such that activity on the same telephony carrier would be indicative of the deactivated phone number being assigned to a new owner. In some embodiments, the aggregator is configured to look for a deactivation activity within any other time window. If a deactivation activity is not found within the time window, the aggregator proceeds to step 1012. If a deactivation activity is found within the time window, the aggregator proceeds to step 1014.

At step 1014, the aggregator compares a telephony carrier listed in the ENUM activity and a telephony carrier listed in the deactivation activity. If the telephony carriers do not match, the aggregator determines that the telephone number was ported to a different carrier (e.g., one of carrier systems 1-N 104) by the customer and proceed to step 1026. If the telephony carriers match, the aggregator proceeds to step 1016.

At step 1016, the aggregator compares the date of the ENUM activity and the date of the deactivation activity. For example, the aggregator checks if the date of the ENUM activity and the date of the deactivation activity are more than a predefined time period apart. The time period may be 48 hours, or another predefined or adjustable time period. In some embodiments, the 48 hours period may be used because it is a sufficiently long time period following a deactivation, such that activity on the same telephony carrier can only be indicative of the deactivated phone number being assigned to a new owner rather than, for example, ENUM activity being out-of-date. If the dates are sufficiently far apart, the aggregator concludes that the ownership of the telephone number has changed and proceed to step 1028. Otherwise, the aggregator proceed to step 1008 to examine the next ENUM activity.

At step 1012, the aggregator further examines the list of time-stamped telephone activities. If the list contains no recent suspension, reactivation, or port activities the aggregator proceeds to step 1020. Otherwise, the aggregator proceeds to step 1018.

At step 1018, the aggregator analyzes the type of the recent telephone activity. If the telephone activity has a reactivation type the aggregator proceeds to step 1022. If the telephone activity has a suspension type the aggregator proceeds to step 1024. If the telephone activity has a port type the aggregator proceeds to step 1026.

At step 1020, the aggregator determines that the ownership of the telephone number has not changed and proceed to continue reassignment tracking.

At step 1022, the aggregator determines that the ownership of the telephone number was suspended, but then reactivated. The aggregator continues reassignment tracking. In some embodiments, the aggregator also recommends a “resume” action to the merchant system. A “resume” action may direct the merchant system to resume calls to the customer.

At step 1024, the aggregator determines that the ownership of the telephone number was suspended. The aggregator then continues reassignment tracking (e.g., the aggregator starts looking for possible reactivation). In some embodiments, the aggregator also recommends a “suspend” action to the merchant system. A “suspend” action may direct the merchant system to temporarily suspend calls to the customer.

At step 1026, the aggregator determines that the telephone number was ported by the owner to a different carrier. The aggregator then continues reassignment tracking. In some embodiments, the aggregator also recommends a “ported” action to the merchant system. A “ported” action may direct the merchant system to update the customer data accordingly.

At step 1028, the aggregator determines that the ownership of the telephone number was changed. The carrier then removes the telephone number from further reassignment tracking. In some embodiments, the aggregator also recommends a “remove” action to the merchant system. A “remove” action may direct the merchant system to stop making calls to the customer and update the customer data accordingly, for example by removing the telephone number form customer data.

In some embodiments, at each of the steps 1020, 1022, 1024, 1026, and 1028, the aggregator edits the customer data accordingly. For example, the aggregator changes the telephone number in the customer data, marks the number as ported or suspended, or edits the customer data in any other suitable way. In some embodiments, the aggregator can report the outcome of the reassignment tracking to the merchant system (e.g., merchant system 102).

It will be understood that the steps of FIGS. 7, 8, 9 and 10 are merely exemplary and that in some implementations, steps may be added, removed, omitted, repeated, reordered, modified in any other suitable way, or any combination thereof.

The foregoing is merely illustrative of the principles of this disclosure, and various modifications may be made by those skilled in the art without departing from the scope of this disclosure. The above-described embodiments are presented for purposes of illustration and not of limitation. The present disclosure also can take many forms other than those explicitly described herein. Accordingly, it is emphasized that this disclosure is not limited to the explicitly disclosed methods, systems, and apparatuses, but is intended to include variations to and modifications thereof, which are within the spirit of the following claims.

What is claimed is:

1. An aggregator system for verifying ownership of a telephone number, the aggregator system comprising:
an input communicatively coupled to a telephony carrier system and configured to receive:
real-time ownership verification data for the telephone number, wherein at least some of the ownership verification data is received from the telephony carrier system, and telephone elements data for the telephone number;
a processor configured to determine an ownership verification score for the telephone number based on the ownership verification data and on the telephone elements data; and
an output for communicating data indicative of the verification score.

2. The aggregator system of claim 1, wherein the ownership verification data comprises customer name data and customer address data, and wherein the telephone elements data comprises disconnection and port history for the telephone number.

3. The aggregator system of claim 2, wherein the processor is configured to determine the ownership verification score based on an ownership match score, wherein the ownership match score is determined based on comparing the customer name data and the customer address data with stored customer data.

4. The aggregator system of claim 2, wherein the processor is configured to determine the ownership verification score based on a last possible reassigned date, wherein the last possible reassigned date is determined based on the reassignment and port history.

5. The aggregator system of claim 2, wherein the processor is configured to determine the ownership verification score based on a comparison between a last possible reassigned date and a date on which ownership of the telephone number was last successfully verified.

6. The aggregator system of claim 4, wherein the processor is further configured to determine a last possible reassigned date by analyzing at least one of swap activity data and deactivation activity data associated with the telephone number, wherein the ownership verification score is based on the last possible reassigned date.

7. The aggregator system of claim 4, wherein the processor is configured to determine the ownership verification score based on at least one of ownership information acquired from public data sources and data acquired from a telephone lookup service.

8. The aggregator system of claim 3, wherein the processor is configured to determine the ownership verification score based on a weighted average of the ownership match score and a score determined based on the telephone elements data.

9. The aggregator system of claim 1, wherein the input is further configured to receive telephone lookup service data, and the processor is further configured to perform ownership reassignment tracking based on the telephone elements data and the telephone lookup service data.

10. The aggregator system of claim 9, wherein the processor is configured to determine that a reassignment of the telephone number has occurred by analyzing at least one of swap activity data, suspension activity data, deactivation activity data, and reactivation activity data associated with the telephone number.

11. A method for verifying ownership of a telephone number:
receiving, using an input of an aggregator system communicatively coupled to a telephony carrier system, real-time ownership verification data for the telephone number, wherein at least some of the ownership verification data is received from the telephony carrier system,
receiving, using the input of the aggregator system communicatively coupled to the carrier system, the telephone elements data for the telephone number;
determining, using a processor of the aggregator system, an ownership verification score for the telephone number based on the ownership verification data and on the telephone elements data; and
communicating, using an output of the aggregator system, data indicative of the verification score.

12. The method of claim 11, wherein the ownership verification data comprises customer name data and customer address data, and wherein the telephone elements data comprises disconnection and port history for the telephone number.

13. The method of claim 12, wherein determining the ownership verification score is based on an ownership match score, wherein the ownership match score is determined based on comparing the customer name data and the customer address data with stored customer data.

14. The method of claim 12, wherein determining the ownership verification score is based on a last possible reassigned date, wherein the last possible reassigned date is determined based on the reassignment and port history.

15. The method of claim 12, wherein determining the ownership verification score is based on a comparison between a last possible reassigned date and a date on which ownership of the telephone number was last successfully verified.

16. The method of claim 14, further comprising:
determining, using the processor of the aggregator system, a last possible reassigned date by analyzing at least one of swap activity data and deactivation activity data associated with the telephone number, wherein the ownership verification score is based on the last possible reassigned date.

17. The method of claim 14, wherein determining the ownership verification score is based on at least one of ownership information acquired from public data sources and data acquired from a telephone lookup service.

18. The method of claim 13, wherein determining the ownership verification score is based on a weighted average of the ownership match score and a score determined based on the telephone elements data.

19. The method of claim 11, further comprising:
receiving, using the input of the aggregator system communicatively coupled to the telephony carrier system, telephone lookup service data; and
performing, using the processor of the aggregator system, ownership reassignment tracking based on the telephone elements data and the telephone lookup service data.

20. The method of claim 19, wherein determining that a reassignment of the telephone number has occurred is based on analyzing at least one of swap activity data, suspension activity data, deactivation activity data, and reactivation activity data associated with the telephone number.

21. A non-transitory computer-readable storage medium for verifying ownership of a telephone number, the computer-readable medium comprising:
computer program instructions recorded thereon, wherein the computer program instructions, when executed by an aggregator system, cause the aggregator system, to perform operations comprising:
receiving, using an input of the aggregator system communicatively coupled to a telephony carrier system, real-time ownership verification data for the telephone number, wherein at least some of the ownership verification data is received from the telephony carrier system,
receiving, using the input of the aggregator system communicatively coupled to the carrier system, the telephone elements data for the telephone number;
determining, using a processor of the aggregator system, an ownership verification score for the telephone number based on the ownership verification data and on the telephone elements data; and
communicating, using an output of the aggregator system, data indicative of the verification score.

22. The computer-readable medium of claim 21, wherein the ownership verification data comprises customer name data and customer address data, and wherein the telephone elements data comprises disconnection and port history for the telephone number.

23. The computer-readable medium of claim 22, wherein the computer program instructions, when executed by the aggregator system cause the aggregator system to determine the ownership verification score based on an ownership match score, wherein the ownership match score is determined based on comparing the customer name data and the customer address data with stored customer data.

24. The computer-readable medium of claim 22, wherein the computer program instructions, when executed by the aggregator system cause the aggregator system to determining the ownership verification score based on a last possible reassigned date, wherein the last possible reassigned date is determined based on the reassignment and port history.

25. The computer-readable medium of claim 22, wherein the computer program instructions, when executed by the aggregator system cause the aggregator system to determine the ownership verification score based on a comparison between a last possible reassigned date and a date on which ownership of the telephone number was last successfully verified.

26. The computer-readable medium of claim 24, wherein the computer program instructions, when executed by the aggregator system further cause the aggregator system to:
determine, using the processor of the aggregator system, a last possible reassigned date by analyzing at least one of swap activity data and deactivation activity data associated with the telephone number, wherein the ownership verification score is based on the last possible reassigned date.

27. The computer-readable medium of claim 24, wherein the computer program instructions, when executed by the aggregator system further cause the aggregator system to determine the ownership verification score based on at least one of ownership information acquired from public data sources and data acquired from a telephone lookup service.

28. The computer-readable medium of claim 23, wherein the computer program instructions, when executed by the aggregator system further cause the aggregator system to determine the ownership verification score based on a weighted average of the ownership match score and a score determined based on the telephone elements data.

29. The computer-readable medium of claim 21, wherein the computer program instructions, when executed by the aggregator system further cause the aggregator system to:
receive, using the input of the aggregator system communicatively coupled to the telephony carrier system, telephone lookup service data; and
perform, using the processor of the aggregator system, ownership reassignment tracking based on the telephone elements data and the telephone lookup service data.

30. The computer-readable medium of claim 29, wherein the computer program instructions, when executed by the aggregator system further cause the aggregator system to determine that a reassignment of the telephone number has occurred based on analyzing at least one of swap activity data, suspension activity data, deactivation activity data, and reactivation activity data associated with the telephone number.
